(19) United States
(12) Patent Application Publication
(10) Pub. No.: US 2014/0095982 A1
(43) Pub. Date: Apr. 3, 2014

(54) Systems, Servers, and Methods for Managing Websites

(71) Applicant: DIY THEMES LLC, Austin, TX (US)

(72) Inventor: Christopher Pearson, Austin, TX (US)

(73) Assignee: DIY Themes LLC, Austin, TX (US)

(21) Appl. No.: 13/630,067

(22) Filed: Sep. 28, 2012

(51) Int. Cl. G06F 17/00

(52) U.S. Cl. 715/235

(57) ABSTRACT

Systems, servers, and methods for managing websites. Some embodiments provide methods which include, according to a user selection of a website skin, activating the selected skin. The skin comprises at least one structural box further comprising structural code for the website. The method also includes receiving a request (for instance a call to a hook) to serve the website. Further, the method includes, responsive to the request, outputting (by echoing PHP code if desired) the structural code with style related code applied thereto according to a reference between the box and a style package (which comprises the stylistic code). The outputting can occur in an order associated with the boxes. In some situations, another skin can be activated. Moreover, a change (or, perhaps, an edit) can be made to another skin and displayed without affecting the website. Moreover, another skin can be selected and associated with the website.

### BACKGROUND

Conventional websites consist primarily of two or more underlying components: one or more content bearing documents defined at least in part by its HTML (hypertext markup language) and a style sheet(s). The HTML document(s) defines the structure and substance (or content) of these conventional websites while the style sheet(s) defines the visual appearance of the same. Often, one or more cascading style sheets (CSS) files are used to provide the styling. Popular website development and maintenance software therefore takes a file-based approach to the problems of developing and maintaining websites. In other words, with heretofore available approaches to website development, HTML and CSS files are manually coded, transmitted to a server, and then stored in memory of some type. Because the developer must be knowledgeable regarding the typically complex code in the HTML and CSS files, and because these files must be transmitted to a web server and stored in memory, such file-based approaches are inherently limiting. These inefficiencies result in websites that are difficult to develop, maintain, modify, etc.

Another problem that plagues conventional website development involves search engine optimization or, perhaps more accurately, how a conventional website performs when examined (“crawled”) by typical search engines. When a search engine crawls a website, the search engine cannot sense the website design as a human being would. Instead, it can only examine the underlying HTML and CSS files (and perhaps any scripting that might be associated therewith) looking for cues such as code containing metadata (about the underlying data) to determine the quality and therefore the ranking of a particular web page.

Many website owners, in addition, modify their site designs (styles) on a frequent basis. To do so using conventional techniques, they must often edit both the underlying HTML and CSS files even though some situations allow either of the HTML or CSS files to remain unedited. Even if all that they want to modify is the appearance (the styling) of a portion of their website, sometimes they cannot edit just the style-related CSS document(s). This complication arises in part because the content/structure-related code and the style-related code intertwine with each other thereby limiting the number of situations in which one or the other (but not both) needs to be edited. In practice, therefore, such edits result in a nearly infinite array of outcomes, each of which will perform slightly differently when examined by typical search engines. As a result, seemingly innocuous edits to a website can cause unintended and often undesirable consequences affecting the performance of the website with search engines (and in other areas as well).

### SUMMARY

The following presents a simplified summary in order to provide a basic understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. Thus, the current disclosure provides systems, servers, methods, etc. for managing websites.

Various embodiments provide systems, servers, methods, and “skins” that will work with any kind of website to provide improved search engine performance, increased design flexibility, and improved loading times. Indeed, unskilled (in terms of code-writing proficiency) users can use a website skin for their particular website. They do not necessarily need to write or edit any code to do so. Instead, they can merely provide their data/content and select a skin to use with it. Thus, some embodiments place the onus of skin development on code-skilled developers thereby allowing typical users to concentrate on their content, not on learning a programming language or writing code. When a typical users wishes to change their website design they can select a new or different skin from a library or their “magazine” of skins and activate it. Their website then changes to reflect the activated skin. Moreover, if a user wants to change a portion of their website's structure, they can replace a structural box with another structural box. Again, their website changes to reflect the newly incorporated structural box. Similar statements can be made regarding certain style packages used to apply style to the structural boxes.

In the current embodiment, skins are collections of structural boxes (with certain properties, options, functions, etc.) that will be used with style packages and perhaps additional CSS and/or images, scripting, etc. For many users, skins serve as a user-friendly point of interaction with the underlying software. The powerful and efficient PHP skin-based framework and easy to use point-and-click controls of some embodiments allow users to precisely and accurately build, maintain, modify, change, fine-tune, etc. (without necessarily editing) their websites and the pages and other structures and styles thereof. Skins of various embodiments therefore free the user from tedious, error-prone, and/or code-intensive editing and allow them to concentrate on adding content to their websites or otherwise improving them. Moreover, skins of some embodiments allow users to evaluate potential changes to their websites without actually launching the changed website and to do so on the same display screen (and/or within the same application) in which they make the prospective change. Furthermore, embodiments enable users to improve their website readability and/or performance by improving their typography and visual clarity through, in part, leveraging website development tools provided by various embodiments.

Instead of conventional file-based template systems, some embodiments provide a data-driven “skin” based systems. These skins include certain components allowing even unskilled users to build esthetically pleasing and fully functional websites. At one layer, embodiments provide skins for websites wherein the skins can act as a complete template system for the users (but with much more inherent functionality than conventional templates). More particularly, the skins of the current embodiment include collections of structural boxes (supplying HTML structure-related code) that cooperate with corresponding style packages (supplying CSS style-related code) at another level. Thus, skin-based systems of the current embodiment allow users to create, maintain, share, modify, change, etc. skins which allow for a large number of esthetically pleasing, fully functional websites.

The skin components mentioned previously can include structural boxes which can be objects encapsulating patterns of code in a mark up language (for instance HTML). These components can also include style package objects which encapsulate a portion(s) of a style sheet code written in CSS (for instance). Moreover, through a graphical user interface, the user can establish references that indicate which style packages provide the styling for the structural boxes. The user can also (via the graphical user interface) define the order in which the system outputs the styled boxes in accordance with a particular active skin. Moreover, the user can define that order separately from choosing various style packages thereby allowing them to focus separately on the ordering of the structural boxes and the stylistic aspects of their websites. This arrangement allows users to focus on the structure and/or content of their websites using the skins while allowing them to focus separately on style by using the style packages.

With further regard to the structural boxes of the current embodiment, they allow developers to interact with the encapsulated code in user-friendly, non-code based ways that conventional systems would find difficulty in duplicating. This result, occurs, in part, because conventional systems typically require developers to hand code their HTML files. Unlike hand-coded HTML (or even HTML generated by conventional automated code-writing systems) which sits statically in a file, structural boxes can have properties, options, and/or functions. As a result a structural box can behave differently in differing contexts. Furthermore, developers can choose and combine these properties, options, and functions in a large number of possibilities limited only by their imagination. The behavior of the structural boxes within particularly skins can therefore be either simple or complex or of some intermediate complexity. For instance, one particular structural box might output the name of a website while another structural box (or the same structural box in a different context or skin) might output numerous pieces of content pulled from a website database. Therefore, users need not re-create structures already provided by existing structural boxes. Instead, they can re-use, adapt, etc. existing structural boxes by changing their properties, options, and/or functions within a skin, thereby unlocking the underlying code for dynamic use and/or re-use.

The current embodiment moreover allows even un-skilled (at least in terms of coding) users to deploy code via a skin that has a relatively high degree of similarity in structure and performance to code deployed by others (if desired). Additionally, the standardization made available by structural boxes means that developers have fewer opportunities to make coding mistakes and syntactical errors. Furthermore, because the output of structural boxes can be standardized, the output of a particular often-used structural box can be scrutinized by observers over time and in a variety of contexts. This potentially increased and persistent visibility can create a feedback loop which can be useful for improving the quality and efficiency of the structural boxes as they are used within a potential multiplicity of skins, contexts, etc.

With regard to style or design, in conventional template-based systems, the CSS code is usually supplied by way of a hand-coded file. If users of these conventional systems want to modify the design of their website, these users must typically hand-edit the CSS code directly (or supply another CSS file of their own). Either way, the user must typically possess proficiency with CSS code to do so with any degree of confidence or even hope of succeeding.

The current embodiment, though, allows developers and even unskilled users (colloquially, “newbies”) to create stylistic effects through new and innovative style packages. Whereas some structural boxes are objects encapsulating or including HTML code, the style packages of the current embodiment encapsulate or include patterns of CSS code. These patterns can be patterns that designers and other users might include in many websites and/or at many locations within a website. The style packages can also encapsulate or include properties, options, functions etc. so that they can behave differently in differing contexts (for instance, when used in conjunction with differing skins). Thus, the underlying CSS code can be created, maintained, deployed, modified changed, and/or otherwise unlocked for dynamic use (without necessarily requiring editing).

Style packages of the current embodiment furthermore have relatively more powerful capabilities for creating, modifying, and/or changing a style than the conventional text editors heretofore used by most style designers (and HTML developers). Style-related (and structure-related) graphical user interfaces supplied by embodiments allow users to view prospective stylistic (and structural) changes to their website live on a “canvas” before having those changes echoed into the actual websites via a skin.

Methods of some embodiments include creating a library of website structural boxes and/or website style packages. They also include accepting a selection of a website structural box and/or a website style package from the library. A reference between the selected website structural box and the website style package is also accepted in these methods. Additional, these methods include rendering a website in accordance with the reference between the selected website structural box and the selected website style package and/or populating it with data/content.

Various methods of the current embodiment include accepting a property, option, and/or function to be associated with the selected website style package. These properties and/or functions can be encapsulated along with the website style package (or even a website structural box). Furthermore, the website style packages and/or website structural boxes can be uploaded and downloaded and can be ad hoc in nature.

Moreover, some methods of the current embodiment include receiving a call to a hook associated with a website and rendering the website in accordance with the hook (and the reference between the selected website structural box and the selected website style package). Various methods of the current embodiment can be performed via a web browser interpreting code (HTML, PHP, etc.) echoed from a skin associated with the website. In addition, or in the alternative, some methods include accepting a potential change to the selected website skin, structural box, style package, the reference there between, or a combination thereof. Further, some methods include displaying a prospective effect to the website of the prospective change approximately as the prospective changes occurs.

Still other embodiments provide other methods for managing websites. Some of these methods include maintaining a library of website style packages on a server. At least some of the website style packages provide styling to a website structural box via a reference thereto. These methods also include uploading a website style package to the library on the server and accepting a selection of a website style package from the library. Additionally, methods of the current embodiment include rendering a website styled in accordance with the website style package and the reference between the website style package and the website structural box (via an interface with the server).

Embodiments provide servers for managing skins for websites wherein the servers each include an interface, a memory, and a processor in communication therewith. The memory of the current embodiment is configured to store a library of website components including a plurality of website structural boxes to provide structure to the websites and a plurality of website style packages to provide styling to the structural boxes. As to the processor of the current embodiment, it is configured to accept a selection of a website structural box from the library, a selection of a website style package from the library, and a reference between the selected website structural box and the selected website style package. Furthermore, the processor is configured to render the website from the selected website structural box, the selected website style package, and the reference there between.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other advantages and novel features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually identifies the figure in which the reference number first appears. The use of the same reference numbers in different figures indicates similar or identical items.

FIG. 1 illustrates a system for managing websites.

FIG. 2 illustrates another system for managing websites.

FIG. 3 illustrates a flowchart of a method for managing websites.

FIG. 4 illustrates a method for editing a style related to a website.

FIG. 5 illustrates a method for changing a style related to a website.

FIGS. 6A-6E illustrate two approaches to created stylized structure.

FIG. 7 illustrates a magazine of skins associated with a website.

FIG. 8 schematically illustrates a graphic user interface for managing websites.

FIG. 9 illustrates two approaches for serving a website.

FIG. 10 illustrates a progression of a website over time.

FIG. 11 illustrates a graphical user interface for managing a website skin.

FIG. 12 illustrates a graphical user interface for managing structural boxes.

FIG. 13 illustrates a graphical user interface for managing style packages.

FIG. 14 illustrates another graphical user interface for managing style packages.

FIG. 15 illustrates code for creating a structural box of embodiments.

FIG. 16 illustrates code for creating a style package of embodiments.

### DETAILED DESCRIPTION

The current disclosure provides systems, servers, methods, etc. for managing websites and more particularly for creating, modifying, maintaining, and changing websites.

Embodiments herein provided systems which output websites including their structure-related code, their style-related code, scripting and other code and/or program-like code (for instance scripts). Systems of many embodiments are compatible with WordPress and other conventional website development tools. Some embodiments employ mechanisms known as skins to do so. At least some of these skins include collections of HTML code and/or CSS code which is related to the HTML code (although embodiments are not limited to either the HTML or CSS languages). In the current embodiment, the HTML code can be provided by structural box objects, traditional HTML code, other structural constructs, and/or combinations thereof while the CSS code can be provided by style package objects, snippets, variables, traditional style-related code, other style-related constructs, and/or combinations thereof.

The objects of the current embodiment are not necessarily flat like conventional code. Rather they can be “three-dimensional” in that they can have properties, options, and functions. As a result, the structural boxes and style packages of embodiments can behave differently in differing contexts. Moreover, they can be uploaded and downloaded as components of a skin(s) or independently thereof with the properties, options, and/or functions necessarily coming along as part of the uploaded/downloaded object. In contrast, conventional HTML and CSS code, when cut and pasted into new files, must be hand-edited to adapt its behavior to new websites, documents, contexts, etc.

Thus, the skins, structural boxes, and/or style packages of embodiments allows user to concentrate on the top-level design and structure and the content and data of their websites rather than writing detailed code to output the same. That is, for instance, when conventional systems require users to write detailed code such as:
<div id=“main” class=“primary”>
   Embodiments allow users to create the content and data of the logical division titled “main” and the stylistic effects of the “primary” style using a skin or some of its components. Thus, instead of coding, users can concentrate on the data and/or content for the logical division “main” and the stylistic effects for the style “primary” while the structure is supplied for them by a skin (with styling applied thereto) which they can graphically select.

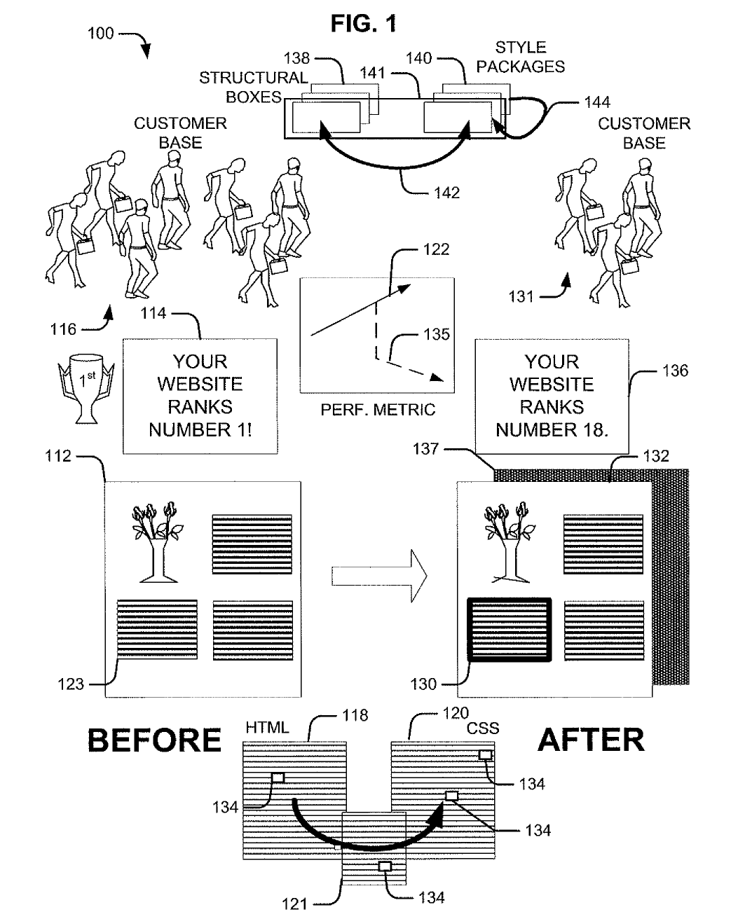

FIG. 1 illustrates a system for managing websites. More specifically, FIG. 1 illustrates that certain “before” aspects of the system 100 and certain “after” aspects of system 100 wherein the difference between the before and after aspects occurs because of is caused by, or otherwise relate to some attempted modification of the website. The system 100 of the current embodiment therefore includes a before-web site 112, a before (search engine) ranking 114, a before-customer base 116, an HTML file 118, a CSS page 120, intertwined targeting expressions 121, a before-performance measurement 122, a before-style 123, an after-style 130, an after-customer base 131, an after-website 132, some website edits 134, an after-performance measurement 135, an after-ranking 136, some unintended consequences 137, a structural box 138, a style package 140, a skin 141, a reference 142, and a style package change 144. Thus, generally, FIG. 1 illustrates the before-website 112, edits 134 thereto, and the after-website 132. As is apparent from the disclosure herein, though, such after-websites 132 can include unintended consequences 137 associated with the edits 134. Moreover, FIG. 1 illustrates an embodiment through which changes to a website can be performed by non-technical personnel and with diminished risks of unintended consequences.

With continuing reference to FIG. 1, website owners often develop before-websites 112 with a view towards attracting and increasing the before-customer base 116. Indeed, by doing so, many website owners wish to profit in a commercial sense or perhaps build a following (or for some other reason). As a result, these website owners often measure the performance of their before-website 112. Various performance measures exist, of course, and include search engine rankings, unique page visits, click-on rates, click-through rates, overall traffic, etc. Moreover, as FIG. 1, shows, it is often the case that website owners desire for their before-performance measures 122 to improve over time.

In the meantime, things change. The content associated with the before-website 112 might change. New or modified functionality or structure might become available for the before-website 112. Or, perhaps, the website owner merely wishes to modify some styling associated with the before-website 112. While this latter exercise might seem trivial, modifying a stylistic aspect of a website is often not a trivial task. Indeed, in many cases, executing such a modification can be time-consuming, error-prone, and cause unintended consequences 137. Editing the HTML file 118 can be even more error-prone and difficult.

These results occur because at least two or more relatively code-intensive and intertwined files underlie conventional websites. More specifically, for each conventional website, an HTML file(s) 118 and a CSS page 120 (or file or files) often exists. Within these files 118 and 120 a series of hard-coded expressions identify which portions of the CSS page 120 apply to which portions of the HTML file 118. These hard-coded targeting expressions are usually intertwined throughout the CSS page 120 and HTML file 118. FIG. 1 therefore shows the intertwined targeting expressions overlapping both the HTML file 118 and the CSS page 120. Note that, although FIG. 1 illustrates the intertwined targeting expressions 121 as being separate from the HTML file 118 and the CSS page 120, that arrangement is not reflected in conventional real-world HTML files 118 and CSS pages 120. Indeed, largely, that situation cannot be so. Therefore, it is only shown as such here to highlight the existence of such intertwined code. Moreover, because, these files 118 and 120 (including the intertwined targeting expressions 121) are developed, coded, maintained, etc. together, it has been found that editing even an apparently innocuous portion of the website can have many (and potentially severe) unintended consequences 137. More specifically, to make even a small modification (from before-style 123 to after-style 130) often involves identifying, analyzing, and editing many code segments in the files 118 and 120 while avoiding edits that might affect the vast bulk of code in these files that is unrelated to the desired modification.

The unintended consequences 137 are therefore legion and cannot possibly be exhaustively listed here. But, they certainly include unintended style modifications that appear apparently randomly throughout a website; apparent alteration of the content of a website (including its apparent deletion in whole or in part); a “crash” of the website; among others. The resulting after-websites 132 therefore might or might not include the desired after-style 130 and might, or might not, include such unintended consequences 137. Clearly, such modifications tend to be error-prone, time-consuming, and frustrating for the website owner as well as the technical personnel involved. When non-technical personnel attempt such modifications using conventional approaches the situation can deteriorate rapidly.

The performance of an after-website 132 can suffer as a result particularly if the underlying HTML is intentionally edited for some reason. But even attempts to edit just the underlying CSS can sometimes backfire when edits to the HTML happen to occur during such efforts (whether intended or otherwise). Thus, the website's after-ranking 136 can (and many times does) drop. And many other after performance measures 135 can decrease or otherwise suffer accordingly. Worse still, in many situations, the first indication that something has gone wrong might be the departure of customers from the before-customer base 116 thereby leaving the website owner with a diminished after-customer base 131. Profits and other sought after results therefore stand a likelihood of corresponding deterioration.

Embodiments illustrated by the skins 141, structural boxes 138, style packages 140, and references 142 there between can alleviate at least some of the foregoing unintended consequences 137 although doing so is not required for the practice of embodiments. Briefly, in the current embodiment, the skins 141 directly or indirectly incorporate structural boxes 138, style packages 140, references 142 there between, and (perhaps) some scripting and/or other aspects related to their corresponding websites. The structural boxes 138 encapsulate HTML code for certain sections of the before and after websites 112 and 132 while also enabling non-code-based methods for changing the same. Likewise, the style packages 140 encapsulate the CSS code for sections of the before and after websites 112 and 132 while also providing more user-friendly change-making capabilities. Moreover, in the current embodiment, independently created references between the structural boxes 138 and style packages 140 allow the style packages 140 to be modified independently of the structural boxes 138 (and vise versa) in many circumstances. The structural boxes 138 and style packages 140, moreover, can encapsulate (or have associated there with) certain properties, functions, options, etc. which help the user perform certain activities associated with the structural boxes 138 and style packages 140. Thus, a particular skin 141 (and its structural boxes 138, style packages 140, references 142. etc. can provide all of the structure and style for a particular website. Although, additional code can be provided by the user if desired. Perhaps interestingly, websites of the current embodiment can have a particular active skin 141 that (while it is active) defines the website presented to the public (or other users) and one or more inactive additional skins 141 that can be used to define the website at times and under conditions selected by the website owner. For instance, in addition to the active web-site-defining skin 141, the website owner 214 can be experimenting with a different skin 141 to determine how their website would perform and/or display should that different website skins 141 be made active.

With continuing reference to FIG. 1, a structural box 138 of the current embodiment is an object which includes a pattern of HTML code. Often, but not always, that pattern of code (or similar patterns) can be re-used in various websites (and/or skins 141). Further, a structural box 138 can include or encapsulate properties, options, and/or functions which can make the structural box 138 behave differently in different contexts. For instance, a relatively simple structural box 138 might output the name of a website whereas a more complex one might output several pieces of content from a website's database depending on how the functions, properties, options, etc. thereof affects its behavior. As a result, in the current embodiment, a user can select a structural box 138, change its properties, options, and/or functions and/or re-use the underlying code. Style packages 140 are somewhat similar to structural boxes 138 but encapsulate CSS code in lieu of HTML code in the current embodiment. Systems in accordance with embodiments therefore unlock the HTML code in the structural boxes 138 and the CSS code in the style packages 140 for dynamic, data-driven, and/or user-defined uses within various skins 141 (or independent thereof in certain scenarios).

Furthermore, whereas modifying a conventional website (or the underlying files) typically involves parsing intertwined code, analyzing the same, editing specific segments of the intertwined code, and avoiding editing other segments of that intertwined code, changing a website of the current embodiment (to the same or similar effect as editing a conventional website) does not usually involve a user editing code. Instead, a user accesses the skin(s) 141, the structural boxes 138, style packages 140, and/or references between them associated with their website at an object level and makes changes to their properties, functions, options, references, etc. In some embodiments, these latter changes are made by way of graphical user interface and/or entails filling in (or changing) entries in various fields, making selections from menus, and/or by other user friendly graphical methods.

It is noted here that “modify,” “edit,” and “change” refer to differing activities. Edit being substantially code-based. Change being substantially non-code based. And, modify being related to making a sought after alteration of a website. Thus, typical users can affect at least two types of changes (among others) via graphical editors of the current embodiment. In some situations, they can change the order of output for the HTML structure (or the order that the structural blocks 138 are output as HTML code) of a particular skin 141. In the alternative, or in addition, they can change the style packages 140, options, functions, properties, etc. associated with particular structural boxes to change how they behave in various contexts. Users can also change skins 141 for the overall website as might be desired and as disclosed further herein.

Regarding the styles associated with a website, the user can make modifications that range from user-friendly changes (often involving little more than pointing at and clicking on style package objects) to more complex editing (for instance, writing actual CSS code) if they so desire. Style packages 140 of the current embodiment therefore represent a more powerful and more user-friendly way to change the stylistic aspects of a website. But users can also (or in the alternative) use some intermediate methods of modifying these stylistic aspects through constructs termed herein “snippets” and “variables” which allow users to avoid intense coding or code-editing activities while allowing them some relatively user friendly access to the underlying CSS code of the website. Thus, style packages 140, snippets, and variables represent improvements over the way style-related code is currently written and deployed. As those skilled in the art will recognize, moreover, CSS is a relatively static language (meaning no processing is typically done on .css files that are stored on a webhosting server: instead the CSS code is executed as-is. As a result, CSS (and similar languages) does not support the use of concepts like variables, snippets, functions, properties, attributes, etc. These languages therefore limit developers and newbies alike, simply because the efficiency gains associated with software re-use have not heretofore been available when using style-related languages such as CSS.

In contrast, the style packages, snippets, variables, etc., (and/or systems, servers, website development applications of the current embodiment) allow users to employ software re-use concepts to style-related coding. More specifically, in the case of style packages, the potential benefits to the user can be significant because large swaths of complicated style-related code can be deployed in seconds via the skins 141 and/or style packages 140 disclosed herein. Furthermore, in accordance with various embodiments, no need exists to re-invent previously created stylistic effects in many scenarios since it is envisioned that many style-related constructs will be re-used over and over again (being distributed via the World Wide Web and other communication technologies) in the various skins 141, style packages 140, snippets, and variables provided by embodiments.

With continuing reference to FIG. 1, the targeting between the HTML files 118 and CSS pages 120 of conventional websites involves coding. For instance, the conventional targeting of a style declaration in a CSS page to a structure defined in an HTML document usually involves creating code “tags” (and/or related code) in the HTML file 118 and the CSS page 120. In contrast, creating a reference 142 with a skin 141 of the current embodiment can involve selecting structural boxes 138 and style packages 140 from amongst lists or graphical displays of the same. In the current embodiment, a website development application of the current embodiment resides in the user's computer and takes care of creating the actual tags based on the user's graphical selections and related entries. Creating a reference 142 can therefore be done graphically in some embodiments.

Further still, typically users write and/or edit their conventional code files (HTML files 118 and CSS pages 120) using text editors (or word processing programs) to edit the text of the code therein. These activities usually entail a fair amount of typing and character-by-character editing and proofing. As a result, it is common for a programmer to identify some website which bears a stylized structure which the programmer wishes to duplicate. Many programmers access the HTML file 118 and CSS page 120 underlying the pre-existing conventional website and “copy and paste” that code (or portions thereof) into their own code. They then line and/or character edit the code until they obtain code that they think will act as intended in their own website. However, that frequently fails to happen thereby necessitating often troublesome and lengthy debugging efforts.

In contrast, skins 141, structural boxes 138 and style packages 140 can be uploaded and/or downloaded via a library of some embodiments. Thus, a user who identifies a structural box 138 from which they wish to duplicate the structure can merely indicate which structural box 138 they wish to have and download the corresponding object from the library (as is disclosed further herein). If they desire that the structural box 138 behaves differently in different contexts, they can change properties, functions, options, etc. associated with the structural box 138 and do so with a graphical user interface rather than text-editing the code. Such users can similarly download style packages 140 which they wish to re-use. Of course, if a user so desires, that user can download an entire skin 141 (including its component structural boxes 138 and style packages 140) and activate it to create or modify their website.

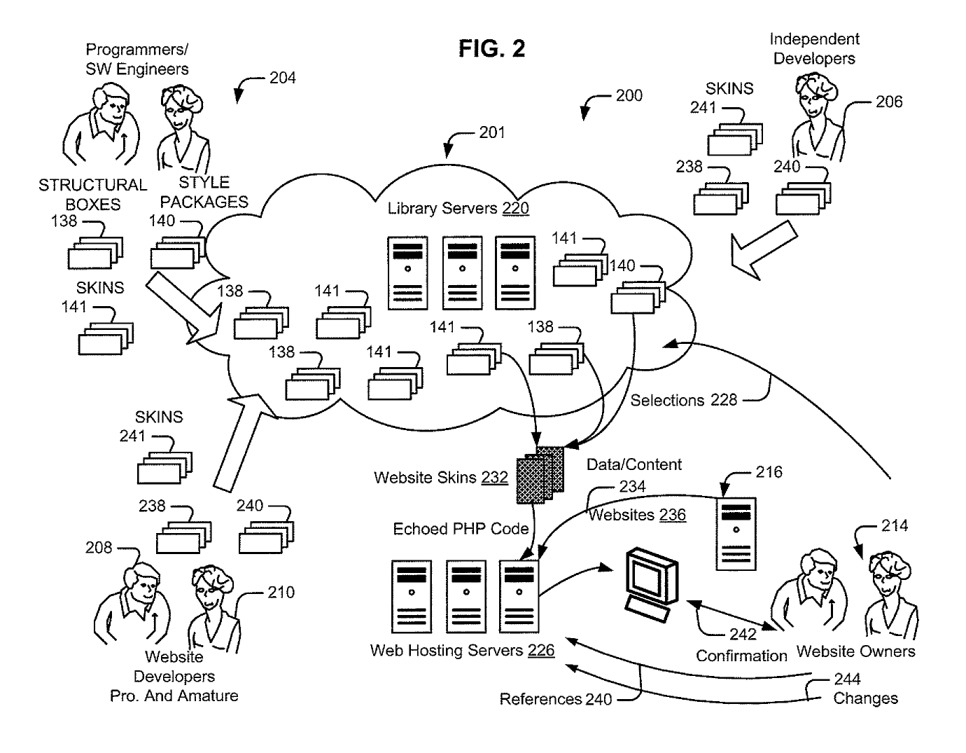

FIG. 2 illustrates another system for managing websites. More specifically, FIG. 2 illustrates the system 200, a skin library 201, a programmer 204, an independent developer 206, an amateur developer 208, a professional developer 210, a website owner 214, an enterprise server 216, several library servers 220, web hosting servers 226, website owner selections 228, website owner references 230, website skins 232, some data/content 234, a website 236, several external skins 241, several external structural boxes 238, several external style packages 240, a website owner confirmation 242, and one or more website changes 244. In the current embodiment, the system 200 allows various users to create and upload skins 141 and 241, structural boxes 138 and 238, and style packages 140 and 240 to the skin-related library 201 while also allowing various users (for instance website owners 214) to build websites 236 from among the same by downloading these objects 138, 140, 141, 238, 240, and 241 therefrom. FIG. 2 also illustrates that some embodiments allow users to develop skins 141 (including their component structural boxes 138 and style packages 140) and to upload them to the library 201. Of course, other users (often website owners 214) can download such skins 141 from the library 201 and deploy them (along with their content) as fully functional websites in accordance with embodiments.

For instance, an owner (or controller, administrator, etc.) of the library 201 can engage programmers 204, software engineers, and the like to develop structural boxes 138, style packages 140, and/or skins 141 which meet standards defined by the library owner. In addition, the library owner can select the programmers 204 based on their qualifications which might include formal training/schooling, industry experience, etc. Thus, the programmers 204 tend to be more professional and to produce higher quality products than others who might be developing the external skins 241, structural boxes 238, and/or style packages 240. The programmers 204 and library 201 owner, moreover, can operate in accordance with some agreement there between so that the library owner controls which objects 138, 140, and/or 141 can be uploaded to the library 201 (and under which circumstances). In this way, among others, the library owner can maintain quality control over at least some of the structural boxes 138, style packages 140, and/or skins 141. Moreover, the library 201 owner can also direct (within their discretion) the development of various families of these structural boxes 138, style packages 140, and/or skins 141.

Of course, the library 201 can reside on one or more library servers 220 which can communicate with other computer/network equipment to facilitate the functions disclosed in relationship with FIG. 2 as well as elsewhere herein. For instance, each user associated with the system 200 will likely have at least a personal computer, a mobile device, or other computing device of some sort and/or a network interface sufficient to communicate with other entities associated with system 200. For instance, the website owners 214 will likely have associated therewith corresponding enterprise servers 216 and/or other computing/communications equipment with which they operate some aspect of the companies, organizations, etc. which they might represent. Typically, these enterprise servers 216 will be executing or storing databases and or other data/content repositories associated with the website owners 214 and/or their respective organizations. It is from such locations (and/or elsewhere) that the webhosting servers 226 can request data/content with which to populate instances of the websites 236 served to various clients and/or other entities.

Moreover, the developers (for instance, programmers 204) will often use computing devices such as laptop computers, desktop computers, development servers, etc. to develop the skins 141, structural boxes 138, style packages 140, etc. These computing devices can include software capable of executing the graphical user interfaces of various embodiments described herein as well as other development related software. For instance, these computing devices will often have PHP editors and other programs capable of editing programs written in scripting languages. In this way, various developers can develop skins 141 for active as well as static websites. Moreover, because the skins 141 (and their underlying components) can be written to have data-dependent functions, properties, options, etc., the data (real-time or otherwise) obtained from the enterprise servers 216 can drive the behavior of the websites 236 via data-driven structural boxes 138 of embodiments.

The webhosting servers 226 can execute software that receives conventional browsing requests from various users and, more particularly, requests for the websites 236 owned by the website owners 214. When one of the webhosting servers 226 of the current embodiment receives such a request, it executes the skin 141 for the requested website 226 that happens to be active at the moment. Executing the skin 141 usually causes the webhosting server to compile the HTML and CSS code for the requested website from an ordered list of the structural boxes 138 and in accordance with the referenced style packages 140. As a result, the webhosting server typically issues a stream of echoed PHP (HTML and CSS code in many situations) to the requesting client (or other requesting machine). When the echoed PUP code arrives at the requesting client, a web browser or other program residing thereon can read the echoed code and display or render the requested website 236 (including data/content obtained from the enterprise servers 216). Accordingly, conventional web browsers can request and receive skin-based websites 236, pages, etc., as well as conventionally generated websites with little or no modification to the web browsers themselves.

The system 200 can also allow developers who are independent of the library owner to operate in conjunction with the system 200. Many of these independent developers 206 are likely to be fairly well skilled. However, the library owner might elect to not exercise control over their activities except, perhaps, with some reactive or proactive authorization to upload the external skins 241, external structural boxes 238, and/or external style packages 240. An agreement might exist between the library 201 owner and the independent developers 206 allowing them upload-related access to the library 201 under certain terms which are likely less stringent than those related to the programmers 204 engaged by the library owner.

In a somewhat similar manner, in the current embodiment, the library owner might also allow another group of developers to operate in conjunction with the system 200. These latter developers might be either amateur developers 208 or more professional developers 210. Thus, some developers in this group might have no, or little, training, schooling, etc. yet they might still be allowed access to the library 201 for the purpose of uploading whatever external skins 241, structural boxes 238, and/or style packages 240 that they might develop. Other more professional developers 210 in this group might have some training, schooling, experience, etc. which might distinguish them qualification-wise from the amateur developers 208. In most cases, though, developers 208 and 210 in this group will probably not have any sort of agreement with the library 201 owner except, perhaps, for having permission to uploaded their external skins 241, structural boxes 238, and/or external style packages 240 to the library 201 for subsequent selection and downloading by themselves and/or others.

Library 201, of some embodiments, will include, store, or otherwise make available a set of skins 141 and 241 (hereinafter skins 141), structural boxes 138, and 238 (hereinafter structural boxes 138), and/or style packages 140 and 240 (hereinafter style packages 140) to the public or some portion thereof. The sets might contain some skins 141, structural boxes 138, and/or style packages 140 developed within a hierarchy or family. For instance, one hierarchy could be defined by the relationships between entertainment:sports:football:teams. On the other hand, some skins 141, structural boxes 138, and/or style packages 140 might be ad hoc in nature. In other words, they might be introduced into, organized within, or come to be uploaded to the library 201 in a more or less random or unstructured manner (at least from the perspective of the library owner). However, certain metadata associated with each or some of the skins 141, structural boxes 138, and/or style packages 140 can aid in organizing, searching, identifying, classifying, etc. the objects within the library 201. In most cases, therefore, the library 201 is, or will come to be, a repository of a variety of skins 141, structural boxes 138, and/or style packages 140. Of course, it might be the case that several such libraries 201 might come to exist or that no one particular library contains all such objects. Rather, many users might come to develop skins 141 (and/or structural boxes 138 and/or style packages 140) and deploy them over the Internet (or otherwise) for re-use, purchase, sharing, etc.

From among the objects in the library 201 users such as website owners 214 can select which objects they wish to use in creating, maintaining, modifying, changing, etc. websites 236 which they own or with which they are otherwise associated. More specifically, the website owners 214 can access the library 201 and peruse the various skins 141, structural boxes 138 and style packages 140 stored therein. The website owners 214 can then select which skins 141, structural boxes 138, and style packages 140 they wish to use in creating (or changing) their websites 236. Additionally, the website owners 214 can identify which style packages 140 apply, respectively, to which structural boxes 138 by way of user-defined references. Note, though, that it is possible for the website owners 214 to edit (the code encapsulated in) the selected skins 141, structural boxes 138, and style packages 140. Nonetheless, in general, the website owners 214 can use the library 201 at an object level to create and/or change their websites 236 without editing code.

More specifically, many website owners 214 will initially opt to download particular skins 141 in their entirety in order to launch, modify, change, etc. their websites. On that note, the skins 141 of the current embodiment generally resemble ordered lists of structural boxes 138 (along with their references 230 if desired). The skins 141 (and its structural boxes 138 and references style packages 140) can be stored at some location in the webhosting servers 226 if desired. Thus, when it is desired for a web hosting server 226 to serve a website 236 to a requestor, the web hosting server 226 can read through the ordered list of structural boxes 128 successively calling on memory for the structural boxes 138 to be styled in accordance with the references 230 (to the selected style packages(s) 140) stored therein. The webhosting server 226 echoes the styled boxes and sends the echoed code representing them to the requesting client. At some point of course, the requesting client can get the data and/or content stored on the enterprise server 216 associated with the website owners 214 to populate the resulting website 236 with the data/content 234 specified by the website owners 214.

Moreover, the website owners 214 can then access their websites 236 (whether populated with data/content 234 or not) via graphical editors disclosed further herein and review it. The website owner 214 can confirm that they are satisfied with the currently rendered version of the their website 236 as-is. While an actual confirmation 242 of such approval is illustrated in FIG. 2, it is not necessary for the practice of the current embodiment. If, however, the website owners 214 wish to make changes to the websites 236, they can submit such changes 244 to the webhosting server 226 which will then affect the desired changes in the skins 232, structural boxes 138, style packages 140, references 230, etc. without the website owner 214 necessarily having to edit code. Website development software, skins, structural boxes, style packages, etc. such as those provided herein are available from DIYthemes of Austin, Tex. and will be marketed under the name Thesis™.

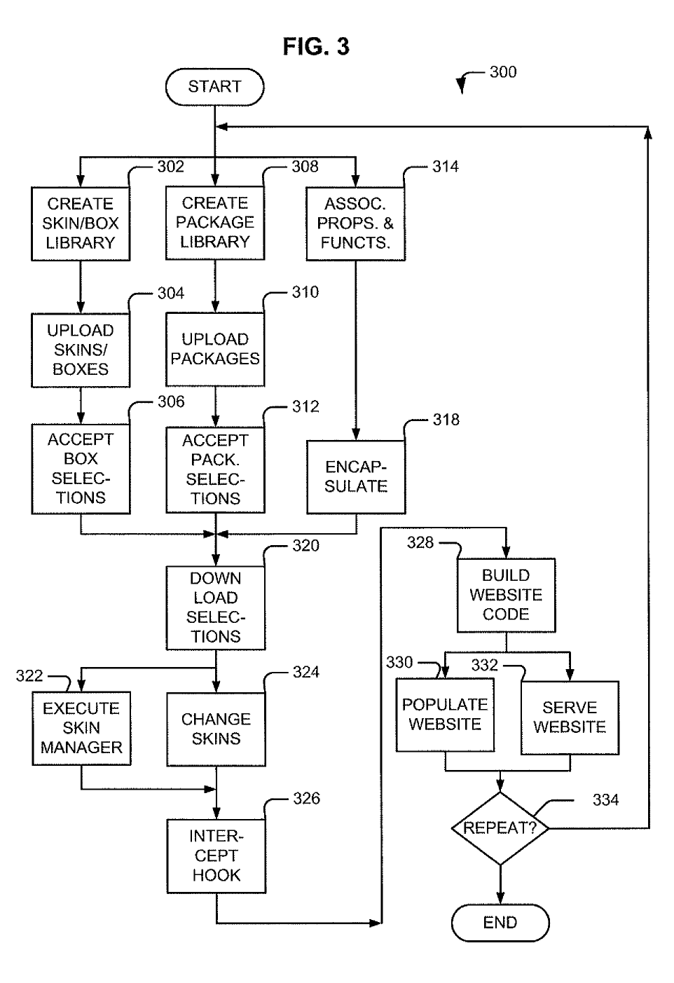

FIG. 3 illustrates a flowchart of a method for managing websites. The method 300 can include a number of activities including creating a library 201 for skins 141 and structural boxes 138. See reference 302. Various skins 141 and structural boxes 138 (including an ad hoc assortment thereof) can be uploaded to the library 201 as illustrated by reference 304. At some point a selection of one or more of these objects in the library 201 can be accepted (see reference 306) with which to build a website 236. Such selections can be made in the context of selecting one or more skins 141 from the library 201, selecting individual structural boxes 138, etc.

FIG. 3 also illustrates that a library 201 for style packages 140 can be created. Of course the libraries 201 for the skins 141, structural boxes 138, and style packages 140 can be the same library 201. See reference 308. Moreover, various style packages 140 can be uploaded to the library 201 if desired and some of these style packages 140 can be ad hoc if desired. See reference 310. As disclosed elsewhere herein, various users can also select from among the style packages 140 in the library 201 for use with various structural boxes 138. See reference 312. Moreover, such selections can be made in the context of selecting one or more skins 141 from the library, selecting individual style packages 140, etc.

With continued reference to FIG. 3, in some embodiments, the various structural boxes 138 and the various style packages 140 are handled in a manner consistent with objected oriented programming guidelines. For instance, each (or some) of the structural boxes 138 and/or style packages 140 can be objects with properties, options, functions, etc. which can be inherited from other such objects. These properties, options, functions, etc., though, can be unique to a given object if desired. Thus, as part of building such objects, method 300 illustrates that such properties, options, and/or functions can be associated with one or more structural blocks 138 and/or style packages 140 if desired. See reference 314. In the alternative, or in addition, these properties, functions, etc. can be encapsulated with their respective structural boxes 138 and/or style packages 140. See reference 318.

At some point, the user selections 228 can be downloaded in method 300. See reference 320. In situations in which a user has selected one or more skins 141, some embodiments allow users to change the downloaded skins 232 if desired. Accordingly, method 300 allows for a skin manager to be executed, opened, accessed, etc. and this can be done before any skins 232 are selected or download. Indeed, the skin manager of embodiments can be used to make such selections. See reference 322. Using the skin manager (or some other tool) the user can change the skin 232 and/or the components thereof including the structural boxes 138, the style packages 140, the references 230, etc. without resorting to editing any code (unless otherwise desired). Assuming that the downloaded skin 232 is active or made active by the user, these changes will take affect in the website. See reference 324.

FIG. 3 also illustrates that once a website 236 is ready to be deployed, hooks referencing the website 236 can be intercepted and re-directed to the webhosting software of the current embodiment. See reference 326. A few words regarding hooks might be useful at this juncture. Certain website creation tools (for instance WordPress) function, in part, by receiving and responding to calls to “hooks” associated with the websites created by such conventional tools. When such a hook is received by a web hosting server 226 of the current embodiment, though, method 300 includes building the appropriate PHP code associated with the selected website skin 232 and populating it with data/content 234 as might be appropriate. See reference 328. As a result, intercepting a hook can cause a website 236 to be served to a requestor in accordance with embodiments. See reference 332. If desired, the method 300 can be repeated in whole or in part as indicated at reference 334.

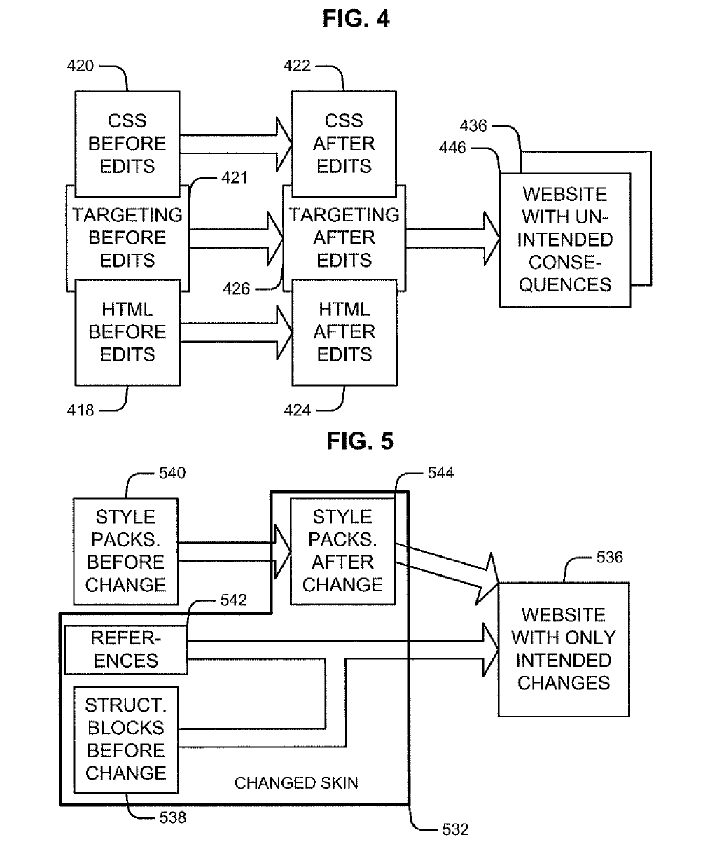

A comparison between FIGS. 4 and 5 might be useful at this juncture. FIG. 4 illustrates a method for editing a style related to a website. FIG. 5 illustrates a method for changing a style related to a website. Whereas FIG. 4 illustrates editing a website built from an HTML, file and a style page (file), FIG. 5 illustrates changing a website 236 rendered from a downloaded skin 532 or, if desired, structural blocks 138, style packages 140, and references 230. More specifically, FIGS. 4 and 5 illustrate that changing a website rendered via a skin 532 is often less complicated, more user-friendly, and less error-prone than editing a website created from an HTML file and a style page or file (of intertwined code).

Recall that conventional websites are coded in intertwined files along with the information required to target certain stylistic aspects to structures defined by those intertwined files. Thus, affecting a change to a conventional website requires editing code that might be poorly written, convoluted, poorly documented, etc. It also requires avoiding editing intertwined code associated with other aspects of the website. These aspects of modifying conventional websites often lead to unpredictable and unintended consequences 137. Thus, FIG. 4 illustrates that a certain set of CSS pages 420 (files), targeting expressions 421, and HTML files 418 exists before a user attempts to edit the underlying website. Of course, the targeting expressions 421 are intertwined throughout the HTML file 418 and the CSS style page 420. The user must therefore edit these code-intensive files to create the modified style page(s) 422, the modified HTML file 424, and the modified and intertwined targeting expressions 426. Since this editing is a code-intensive activity, it usually requires skilled programmers and is nonetheless inefficient and error prone.

In contrast, to change the style of a website 236 in accordance with embodiments, a user can merely change their selection of the style package 540 to a different style package 544. Or the change between the style packages 540 and 544 can be affected by merely accessing the existing style package 540 object at the object level and changing it or its functions, options, and/or properties. A different skin 532 could also be selected, downloaded, and/or made active. But, actually editing the existing CSS code encapsulated in the style package 540 is not usually required nor is it usually required to edit any code associated with the independently created references 542 (since there is no or little such code to be edited except at an underlying level in the website development application of the current embodiment). Rather, the existing references 542 and structural boxes 538 can often be reused as-is in the new (or changed) website 236. Likewise, a change to the structure of a website 236 can be affected by changing the pertinent structural box 538 (or skin 532) rather than editing the underlying HTML code, the targeting expressions 421 and/or the style pages 422 (or rather the code thereof). As a result, whereas FIG. 4 illustrates the likelihood of causing unintended consequences 436 as opposed to producing the desired website 446, FIG. 5 illustrates the increased likelihood of creating a website 536 with only the intended changes.

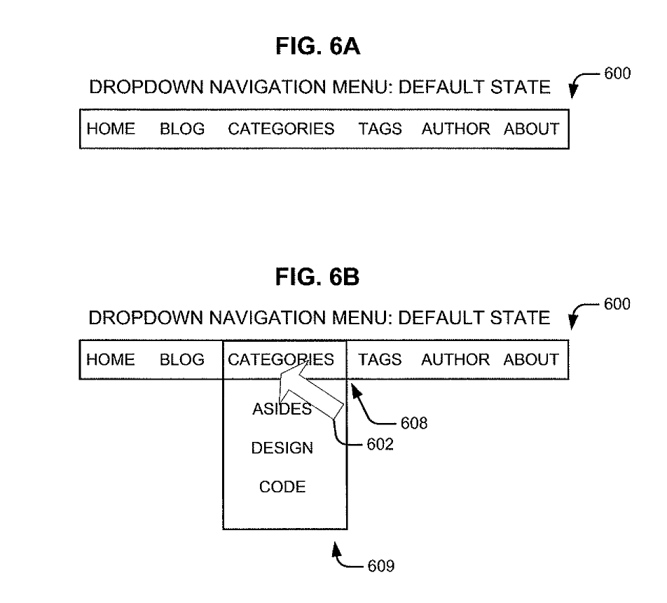

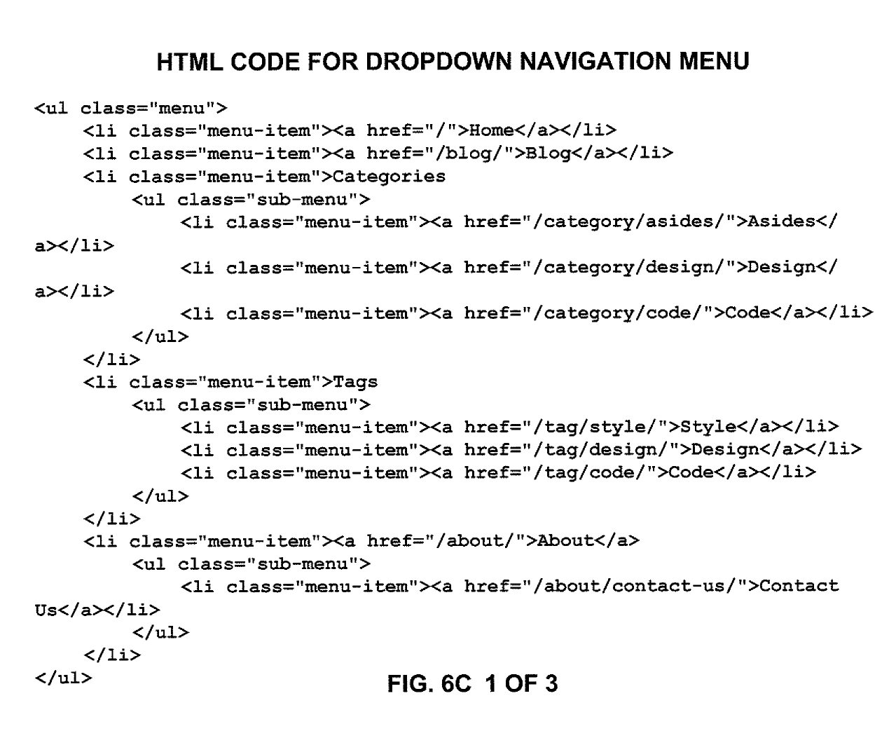

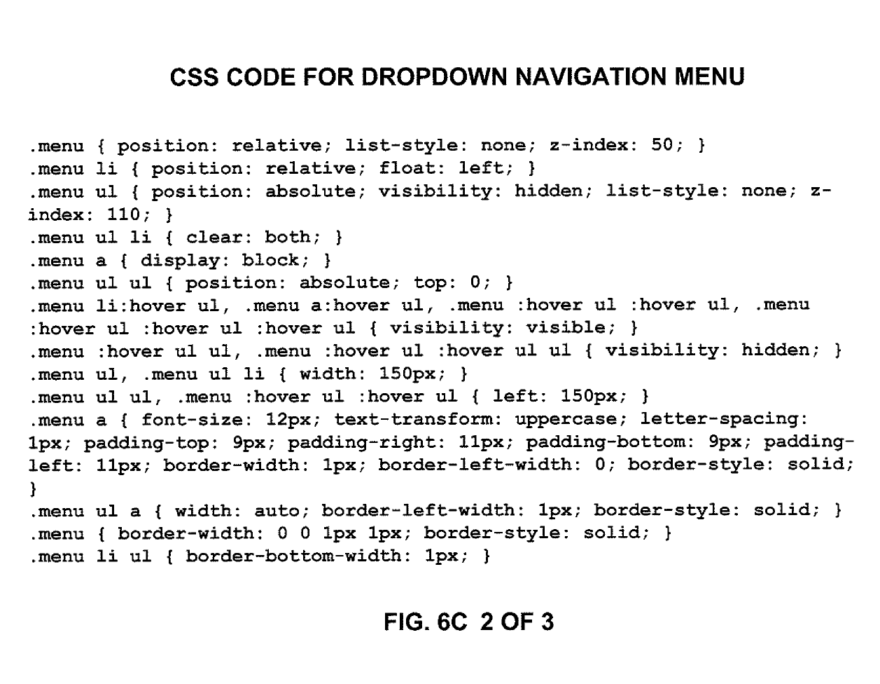

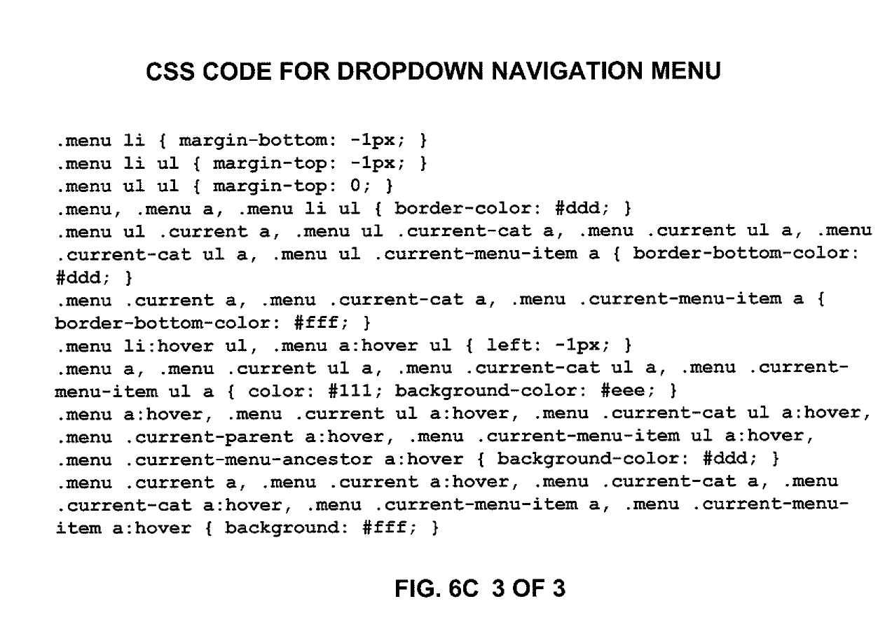

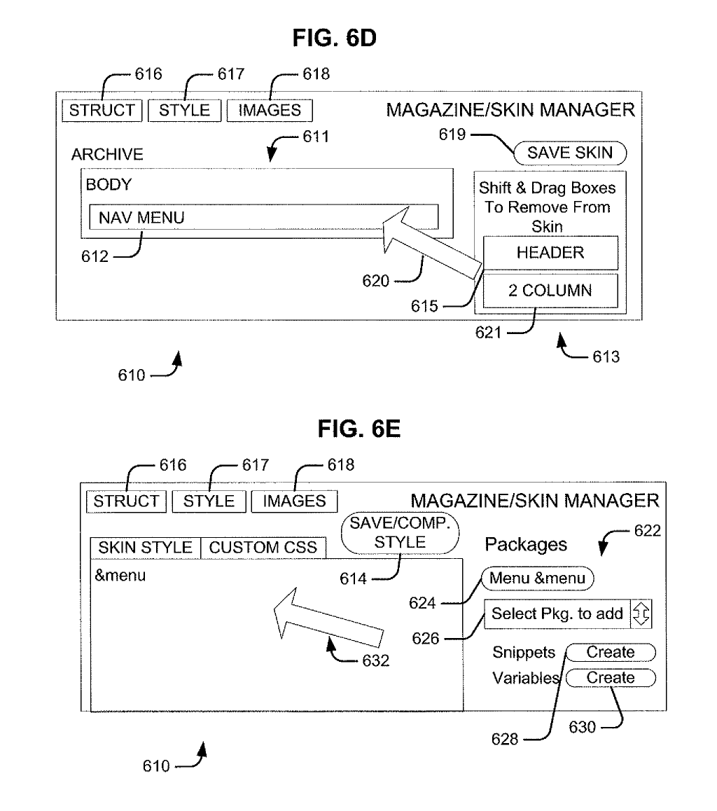

FIGS. 6A-6E illustrate two approaches to creating stylized structure. More specifically, FIGS. 6A-6E illustrate an instance of using structural boxes and style packages to create a drop-down navigation menu for a website and an instance of doing so using conventional code. FIGS. 6A-E illustrate advantages provided by embodiments over previously available website development systems. With more particular reference to FIG. 6A, this drawing illustrates a typical navigation menu 600 in its default state. FIG. 6B illustrates the same navigation menu 600 in a state in which a user has caused a cursor 602 to hoover over the “Categories” link 608. Thus, whereas in FIG. 6A no link is highlighted with its sub-links visible, in FIG. 6B the Categories link 608 is highlighted and the sub links 609 for “Asides,” “Design,” and “Code” are visible and ready to accept the focus of the pointing device should the user hoover over one of them. In contrast, FIG. 6C illustrates typical HTML and CSS code that could be used to produce the navigation menu shown in FIGS. 6A and 6B. Notice that this task required over two dozen relatively intense lines of HTML code and about the same number of lines of relatively intense CSS code. Usually, writing such code requires at least some training.

While producing the HTML code used to create various navigation menus can be mostly automated in some website development systems, the related CSS code is still hand-coded in most, if not all, website development systems heretofore available. Furthermore, such hand-coded CSS suffers from a number of problems. For instance, cross-browser compatibility is often lacking as is the level of expertise and understanding often required to produce solid, professional-grade output. With website development systems of the current embodiment, this process can be performed in a more user-friendly manner than with previously available systems.

To produce the HTML for the navigation menu 600 using a system of the current embodiment, a user can drag a navigation menu structural box 138 over to an active skin area 611, as shown in FIG. 6D. More specifically, FIG. 6D illustrates a number of aspects of a graphical user interface (GUI) 610 of the current embodiment. More specifically, FIG. 6D illustrates that the GUI 610 displays the active skin area 611 with the active skin 612 therein. The GUI 610 also includes a box selection area 613 with two structural boxes 615 and 621 therein having been previously selected from a library by the user for potential use with the selected skin. The GUI 610 also includes controls 616-619 for navigation among various windows of the GUI 610. For instance, tabs 616, 617, and 618 allow a user to respectively select between windows for changing structure related aspects of the active skin, changing style related aspects of the active skin, and modifying the list of images selected for the corresponding website. Control 619 allows the user to save changes to the active skin. Thus, to add a navigation menu to the active skin, the user can select and drag a navigation menu related structural box 138 from the box selection area 613 to the active skin area 611 as indicated by arrow 620.

Creating the CSS code can also be relatively easy. Instead of hand-producing the (relatively intense) two dozen or so lines of CSS code required for a typical navigation menu 600, the user can add a navigation menu related style package to the list of style packages that can be referenced to the structural boxes in the active skin as illustrated by FIG. 6E. More specifically, FIG. 6E illustrates additional controls for changing style related aspects of the active skin. Indeed, FIG. 6E illustrates that the GUI 610 can include an area 622 for displaying style packages already selected for potential referencing to structural packages within the selected skin. The GUI 610 can also include a control 614 for saving changes related to various stylistic aspects of that active skin. FIG. 6E also illustrates various controls in a style-related selection area 622. This style selection area 622 can include a number of icons 624 representing style packages that have already been selected for use with the active skin. It also includes a control 626 for navigating to and selecting style packages 140 from various libraries. The style-related selection area 622 can also include controls 628 and 630 for respectively creating snippets and variables if desired. Depending on user desires, therefore, the GUI 610 allows various stylistic constructs to be added to the selected skin. Here, arrow 632 indicates that a menu-related style package has been added. Note also that the “&” indicates to the system that this object happens to be a style package.

If desired, the user can also access a pop-up window to change options associated with the navigation menu thereby achieving differently styled output (with differing fonts, colors, etc.) as is discussed further herein. Doing the foregoing and other style-related activities graphically is usually quite a bit easier that writing the corresponding CSS code. Indeed, with systems of various embodiments, any user capable of using a mouse or other pointing device can select different values for the various options instead of having to comb through a file of probably intense CSS code and edit the corresponding values buried in that code.

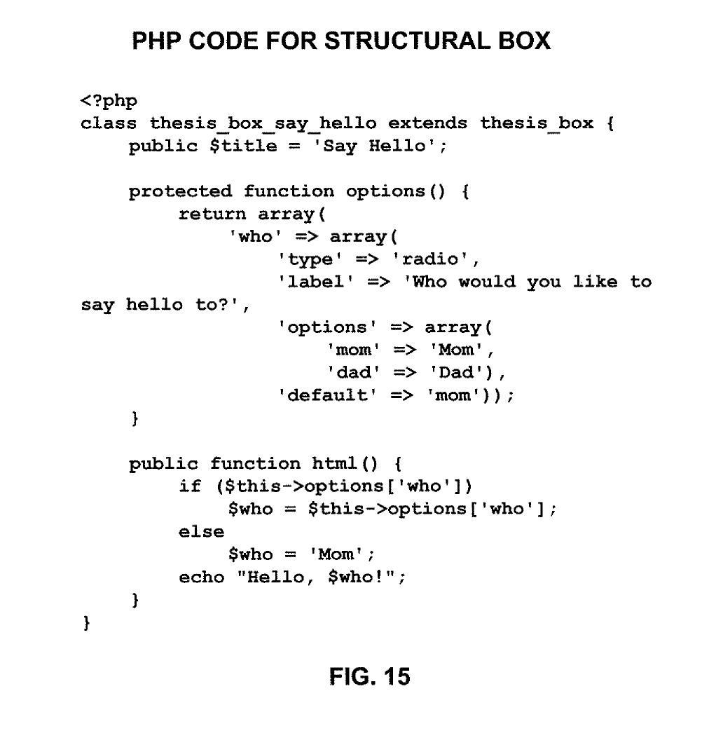

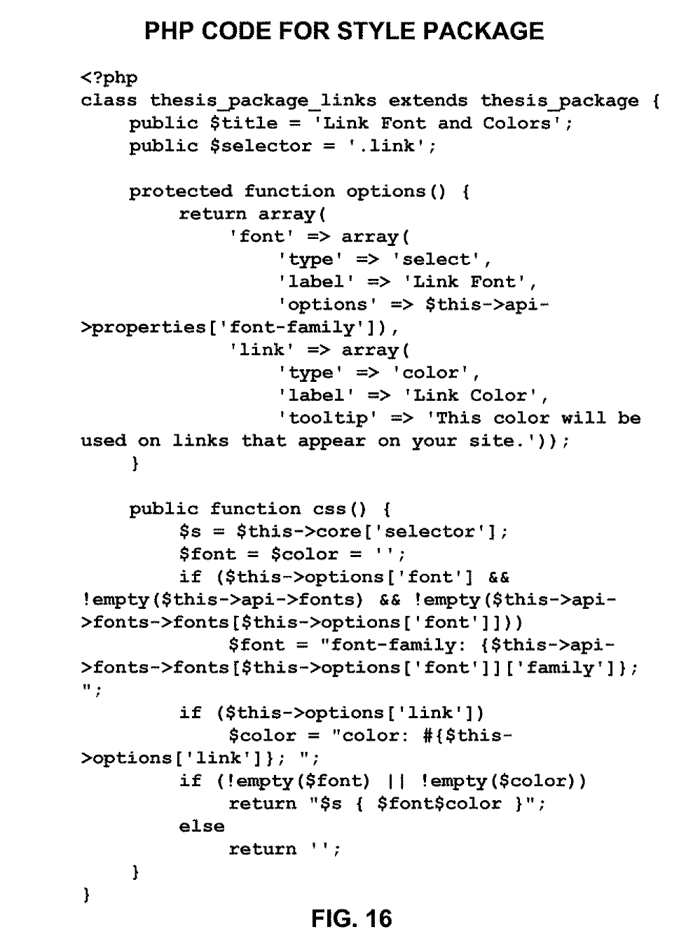

With reference now to FIG. 15, this drawing illustrates code for creating structural boxes 138 of embodiments. Meanwhile, FIG. 16 illustrates code for creating style packages 140 of embodiments. Of course, FIGS. 15 and 16 represent one of many ways to create structural boxes and style packages respectively. Those skilled in the art understand that many other ways exist to create structural boxes 138 and style packages 140. Moreover, they understand that, as objects, the resulting structural boxes and style packages will likely inherent many properties, functions, options, characteristics, etc. from another master object defined elsewhere in the system. Moreover, developers can define such master objects with the properties, functions, options, characteristics which they deem desirable for inclusion in their website development applications, software, systems, etc.

With regard to FIG. 15 again, FIG. 15 illustrates PHP code of certain embodiments for creating a relatively simple structural box. This particular structural box provides the structure for displaying a “Hello” for either “Mom” or “Dad,” depending on a user selection of a single option. FIG. 16 illustrates a relatively simple style package 140 that could be used to change the color and font size of links provided by the structural boxes (provided by the code shown in FIG. 15) to which a reference indicates that that style package 140 should be applied.

Of course, graphical elements of a GUI 610 (see FIGS. 6E, 6D, 8, and FIGS. 11-14) linked to instances of the foregoing code could allow non-technical users intuitive, easy-to-use mechanisms with which to change specific skins 141, structural boxes 138 and/or style packages 140 downloaded from those stored in the library 201 or elsewhere.

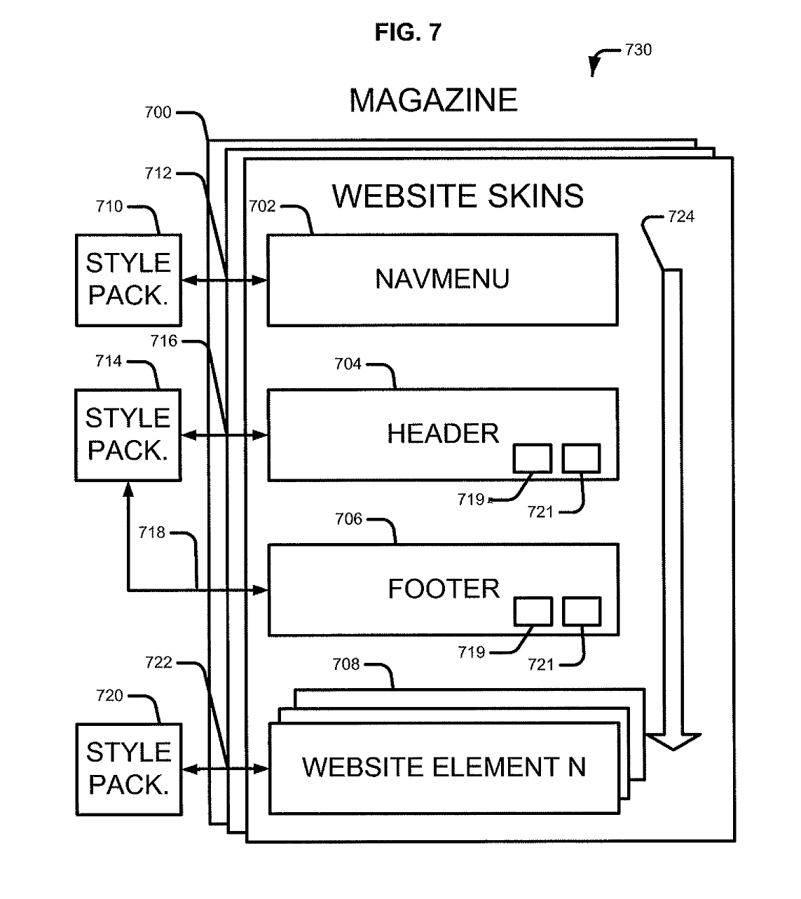

In the meantime, FIG. 7 illustrates a magazine of skins associated with a website. The skins 700 of the current embodiment can serve as website templates for websites 236 where these “templates” are created from selected structural boxes 138, their associated style packages 140, and the references 142 there between. Skins 700 of the current embodiment provide greater flexibility and user friendliness than website templates of conventional systems. Moreover, skins 700 of embodiments can be operated upon within the context of a browser rather than within some text editor or other text manipulation context. Furthermore, skins 700 can be compiled at run time and populated with data/content 234 specified by the website owner 214 or other user by making a priori (or real-time) designations of what data/content to use to output a website 236 or portion thereof.

Typically, websites 236 include multiple page structures each defining additional sub structures, containing differing data/content 234, and being styled in differing manners. Skins 700 perform several functions related to building such websites 236. For instance, they allow a user to select and/or organize the structural boxes 138 they have chosen (or are in the process of choosing). Thus, a user can add structural boxes 138 to a skin 700 to build an entire website 236, a page of a website 236, or other structures therein. Moreover, FIG. 7 illustrates one set of such selections having been made by a user. Here, the user has chosen (from the library 201) a series of structural boxes 702, 704, 706, and 708. Each of these structural boxes 702, 704, 706, and 708 defines corresponding structure for the intended website 236 under development (or modification) generally by way of changes as opposed to edits. If desired, one or more structural boxes 138 can be nested within other structural boxes 138 to provide additional flexibility and user-friendliness.

The skins 700 can also work in conjunction with the selected style packages 140. For instance, style package 710 (having been selected by the user to do so) defines the style for the structural box 702 as indicated by the user-entered reference 712. Likewise, style package 714 defines the styling associated with structural box 704 as indicated by reference 716. However, FIG. 7 illustrates that the user decided to reuse style package 714 to also define the styling associated with structural box 706 as indicated by reference 718. And, to some extent this might make sense and/or be efficient. For instance, both structural boxes 704 and 706 are illustrated as being (or defining) margin-located structures such as headers and footers. In such situations, a user might want the styling to be similar. Hence, their reuse of style package 714.

In the current scenario, moreover, the user also selected a series of structural boxes 708 to define a corresponding series of structures on the website 236. For instance, the user might be establishing a blog hosting website. In which case, each blog posting might have multiple (and similar) posting-related structures therein. The user has, in this scenario, therefore selected one particular structural box 708 and replicated it to provide the posting-related structures. In such cases, FIG. 7 illustrates that the user can use one style package 720 (with multiple references 722) to style the series of structural boxes 708 or, rather, the corresponding series of website structures.

In another instance, one commonly sought after stylistic effect that a style package 720 could supply would be typography. Typography refers to the stylistic interplay between differing text-containing structural elements and can have an impact on a website's effectiveness. In part, this is believed to be the case because typography affects the visual appearance of one of the major classifications of content and data on most websites: text. One consideration involved in getting the typography to be effective or at least esthetically pleasing is the size relationships between the fonts of headers, footers, main bodies, etc. in the text. Having unappealing typography can turn away, repeal, etc. viewers and lower the performance of a website 236. DIYthemes of Austin, Tex. provides skins 700 with esthetically appealing typography. In such skins 700, the typography defines certain characteristics of a website 236 such as ratios between font sizes that have been found to produce aesthetically pleasant text-based content.

The website development software of some embodiments includes a typography-related application program interface (API) which developers can choose to include in particular style packages 140. That API contains tools which allow users to incorporate and/or change, modify, etc. typographic-related styles within their websites. Some embodiments, by default, include this API in the style packages 140 although that aspect can be overridden if desired.

In addition, a property 719 encapsulated in some structural boxes 704 and 706 might indicate whether the user desires those structural boxes 704 and 706 to be a header or footer. In which case the property 719 causes the webhosting server 226 rendering the website 236 to place the corresponding structure at the top or bottom of the page(s) respectively. In the alternative, or in addition, a function 721 (or option, characteristic, etc.) encapsulated in the structural boxes 704 and 706 could determine whether one or the other of the structural boxes 704 or 706 immediately follows a page-building structural box 138. In which case, the function 721 might treat the structural box 704 or 706 as a header. If not, the function could treat the structural box 704 or 706 in some other fashion for style-related purposes. Of course, the properties 719 and functions 721 could provide functionality as desired by users. For instance, some functions 721 could provide http( ) output capabilities, save( ) capabilities, etc.

Moreover, FIG. 7 illustrates that the skins 700 of some embodiments allow the user to designate an order 724 in which to build the structures related to the selected structural boxes 702, 704, 706, and 708. Indeed, FIG. 7 illustrates the order 724 in which a website hosting server 226 can build the structures. A user can therefore specify that a particular page (or pages) be built, then the headers, footers, and other related structures can then be built. Such functionality can be helpful when building nested and/or repetitive structures (such as blog posts, comments, etc.). Thus, once a user has assembled a skin 700 (or series thereof), their associated website hosting server 226 can build the structures, apply the style, and populate the website 236 with data/content (as specified by the user) and output the website 236 to a requesting browser, client, etc.

Of course, the titles (such as Navmenu, Header, Footer, etc. given to the structural boxes 702, 704, 706, and 708) can be arbitrary. The titles need not relate to the actual structure created by their underlying HTML code. However, some users might want to title the structural boxes in such a manner and systems 100 of the current embodiment support such naming conventions.

Moreover, as noted elsewhere herein, FIG. 7 illustrates a magazine 730 of skins 700 associated with a given website. The magazine 730 can be stored in a webhosting server 226 used for the website 236. Indeed, the magazine 730 can be accessed via the GUI 610 disclosed further herein. The magazine 730 includes the various skins 700 downloaded from the library 201 and associated with the particular website 236 by the user. Thus a many to one correspondence can exist between the skins 700 in the magazine and the website 236 with one particular skin 700 being active (and therefore defining the active website 236) at a given time.

The ability of the webhosting servers 226 of the current embodiment to execute the skins 700 and create echoed PHP code for the website 236 allows users flexibility in their use of the skins 700 in the magazine 700. More specifically, as stand alone data structures (all capable of acting independently with the data/content of a website 236) the skins 700 allow the user to accomplish one task with one skin 700 and to accomplish another task with another skin 700. For instance, by activating one skin 700, the user exposes that skin (or rather, the echoed PHP code generated from it) to a community via the Internet or other communications technology. That skin 700 more or less serves as the website for this purpose in this scenario. The user, though, can be experimenting with another skin 700 to see how changes they are interested in making might affect the website 236. Thus, a version of the website 236 corresponding to a trial skin 700 could be viewed via a graphical manager as changes are being made to that trial skin 700 without affecting the apparent website 236 generated using the other skin 700.

Further still, in part because the webhosting serve 226 typically executes the active skin 700 each time a browser makes a request for the website 236, skins 700 in the magazine 730 can be changed on the fly. More particularly, as time passes and various browsing requests are received, the webhosting server 236 will echo a version of the website 236 corresponding to the skin 700 that is active at the time of the request. In the meantime, a user can indicate that a different skin 700 in the magazine is active and all requests from that time forward will cause the webhosting server 226 to execute that designated skin 700 instead of the previously active skin 700. Thus, in the time that it would take a conventional server to serve a conventional website, webhosting servers 226 of the current embodiment can switch between skins 700 and serve the version of the website 236 corresponding to the newly designated active skin 700 without apparent interruption or delay as viewed by the requestor.

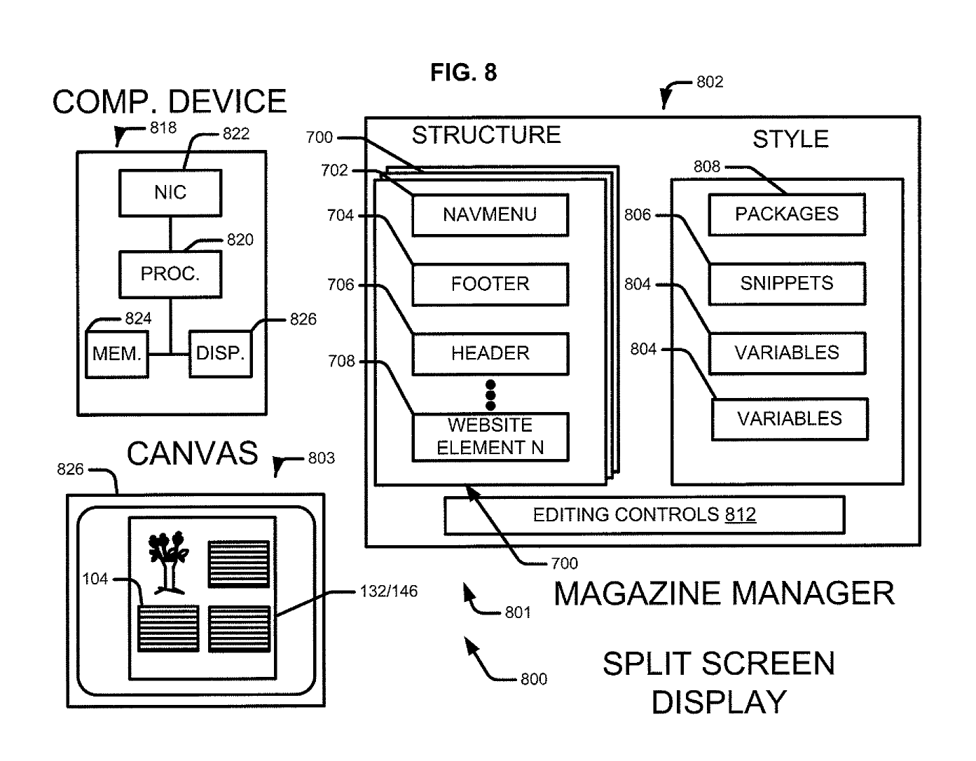

FIG. 8. Schematically illustrates a graphic user interface for managing websites. The graphic user interface (GUI) 800 includes a magazine manager 802 or change management window which allows users to change, maintain, etc. the skins 700 and other underlying aspects of websites 236. The other component of the current embodiment is termed herein a canvas 803 and is a real-time or near real-time rendering of what the website 236 would look like if the prospective changes being entered via the magazine manager 802 were actually output as the website 236. Thus, the graphical user interface 800 allows users to make prospective changes to their websites 236 while watching the prospective effects, results, etc. on the canvas 803 for intended as well as unintended consequence with as little delay as the system takes to execute the trial skin 700 defining the prospective effects.

More specifically, the magazine manager 802 portion of the GUI 800 displays the skins 700 in the magazine 730 selected or created for a given website 236 or page thereof as well as the structure and style related objects thereof. The magazine manager 802 can be programmed to allow the user access to at least some of the options associated with the structural boxes 702, 704, 706, and 708. If the user elects to change one or more of these options, the function-related behavior of the changed structural box 702, 704, 706, or 708 might be affected accordingly. Changing an option might also affect the HTML code echoed when the website is served to a requestor and thus the rendering of a portion of the website might change accordingly. In some embodiments, though, the magazine editor 802 is programmed to not allow user access to the functions associated with the structural boxes 702, 704, 706, and 708.

Since the structure-related objects of embodiments are discussed with reference to FIG. 7 (and elsewhere) some comments regarding style-related objects might now be in order. Thus, the magazine manager 802 displays the style packages 808 as well as other style-related components for a website 236. For instance, in some embodiments, the magazine manager 802 allows users to create, maintain, modify, etc. certain types of style-related variables 804. Generally, a user can define a style-related variable 804 by naming a style related property and pairing it with some value. So, one instance of a variable would be color: green. Then the user can use the variable “color” to designate that some structure be that color, here green.

Snippets 806, in the current embodiment, are groups of variables and can likewise be given a name. While variables 804 allow users to identify one particular value for one particular property, snippets 806 allow users to identify values for groups of variables. If, for instance, a user wished to define a shadow style element, the user could create a snippet 806 which defines the color of that shadow, its width, its opacity, and/or any other stylistic features of the shadow.

The magazine manager 802 of the current embodiment allows users to change any of the foregoing via a variety of change management controls 812 presented by the GUI 800. Moreover, as the user changes the various aspects of the website 236 via the magazine manager 802, the GUI 800 displays what the website 236 would look like after the change takes effect in the canvas 803 (as the user makes those prospective changes if desired). As a result, users can make prospective changes to their websites 236, view the results, and choose to save or reject those prospective changes before committing them to the actual website 236.

With continuing reference to FIG. 8, the magazine manager 802 of the current embodiment therefore provides users the ability to use at least three CSS related components: variables 804, snippets 806, and style packages 808. In the current embodiments, variables 804 are used in conjunction with standard CSS values (and/or their counterparts in other style languages). These CSS values include, but are not limited to, those related to colors, fonts, sizes, etc. Variables can be useful for creating, changing (and/or testing changes to), etc. the stylistic properties of many structures at the same time.

Snippets 806 can bring efficiency to the use of property:value pairs which often appear in patterns which repeat throughout a given website and even across websites. The snippets 806 of the current embodiment can be used multiple times within a style package 808, page, or document). Again, some snippets 806 are collections of variables or properties and can define more complex stylistic effects than most variables 804 can. For instance, consider a typical style-related declaration:
Border: 3px double #ddd; border-width: 0 0 3px 0;

Typically, a designer might write that code into a conventional CSS page when trying to give a double border to a bottom of a specific element(s). But, in the current embodiment, a user could use a snippet to do the same thing to many structural elements with one such entry. Indeed, the user could give the above piece of code a name such as “border1.” Then, the user could add this snippet to their style package or document by using the name of the snippet as follows: ?border1 and apply it to the elements which they want it to affect as follows.

element_{—}1 {?border1}
element_{—}2 {?border1}
element_{—}3 {?border1}

The system of the current embodiment would recognize (by the “?” in the current embodiment or some other indicator) that the user is calling for a snippet named border1. This aspect of the system saves space. It also allows a user to change many properties at once (by changing the snippet). For instance, if the user wanted to change the color of these borders, the user could change the snippet once, rather than once for each of the affected elements. This approach contrasts with conventional systems in which the user (most likely a developer or other code savvy individual) would have to parse an entire CSS file while making a line-by-line, character-by-character edit of that entire code-based file to attempt to affect the same series of modifications. It is noted here that while some code editing like activity might be associated with modifying variables and snippets, engaging in these activities is not required for the practice of embodiments. Rather, the ability to modify (and/or use) snippets is provided to allow those users who wish to use these style-related constructs to do so. In this way they can leverage the coding efficiency associated with re-using style packages 140 with their use of these variables and/or snippets. It might be worth noting that users could create, modify, etc. websites without resorting to either snippets, variables, or both and still create websites within the scope of various embodiments.

With continuing reference to FIG. 8, style packages 802 also allow users flexibility in creating, modifying, changing, etc. websites in a user-friendly manner. For instance, many pages of many websites include various navigation aids such as dropdown navigation menus. The HTML for such a feature can be standardized and repeated across these websites and pages by using structural boxes 138 and style packages 140 provided herein. Thus, the user could select a structural box 138 that provides a navigation menu (but without styling). However, many users think of navigation menus as dropdown menus that appear along the top of their screen. Furthermore, many users might find the navigation menu without styling (which would be a mere list of navigation links) to be un-esthetic. To create a dropdown menu and place it along the top of the viewer's screen at appropriate times (and with frequently desired options) requires much complicated CSS code. Few users could be expected to develop that sort of code in any reasonable time. Indeed, such coding likely exceeds the talents of all but a few website owners. Worse still, this CSS code must work in a variety of differing browsers, on many different platforms, under many differing contexts, etc. which many website owners might not foresee or know how to accommodate.

To avoid rather predictable (and unpredictable) reactions from users, the user creating the website could associate that structural box 138 with a style package 140 of the current embodiment. That style package 140 could provide the CSS code typically used to create horizontal dropdown menus (out of the list of navigation links output by the structural box 138). Style packages 140, of course, can also provide the styling for other structures such as email signup forms, typography, and many more types of often-used structures (as well as other less-used structures).

By using style packages 140 in conjunction with the magazine manager 802, users can graphically deploy these patterns of CSS code rather than writing (from scratch) a new version of such encapsulated CSS code each time they wish to use that stylistic effect. Accordingly, style packages 140 of embodiments can provide consistency and order on a large scale. Style packages 140 of embodiments also represent an innovation for designers and especially for users who lack code-suaveness in the first place or at other times.

FIG. 8 also schematically illustrates a computing device capable of executing programs, browsers, web hosting server software, etc. as further disclosed herein. The computing device 818 includes a microprocessor (or other circuit or device currently available or that might arise in the future) capable of executing programs, instructions, etc. encompassing various methods disclosed herein. The processor 820 communicates with a network interface 822 to send/receive information to/from other computing devices (and perhaps even various users). Additionally, in the current embodiment, the computing device 818 includes a memory 824 for storing the programs, machine-readable instructions, etc. as well as the data, content, etc. on which they operate. The memory 824 could be any type of memory (or machine-readable medium) currently available or that might arise in the future. FIG. 8 also illustrates that the computing device includes a display 826 and/or other user interface components which communicates with the other components of the computing device 818 to do so. Again, the display 826 can be any type of display (or any other type of user interface components) currently available or that might arise in the future.

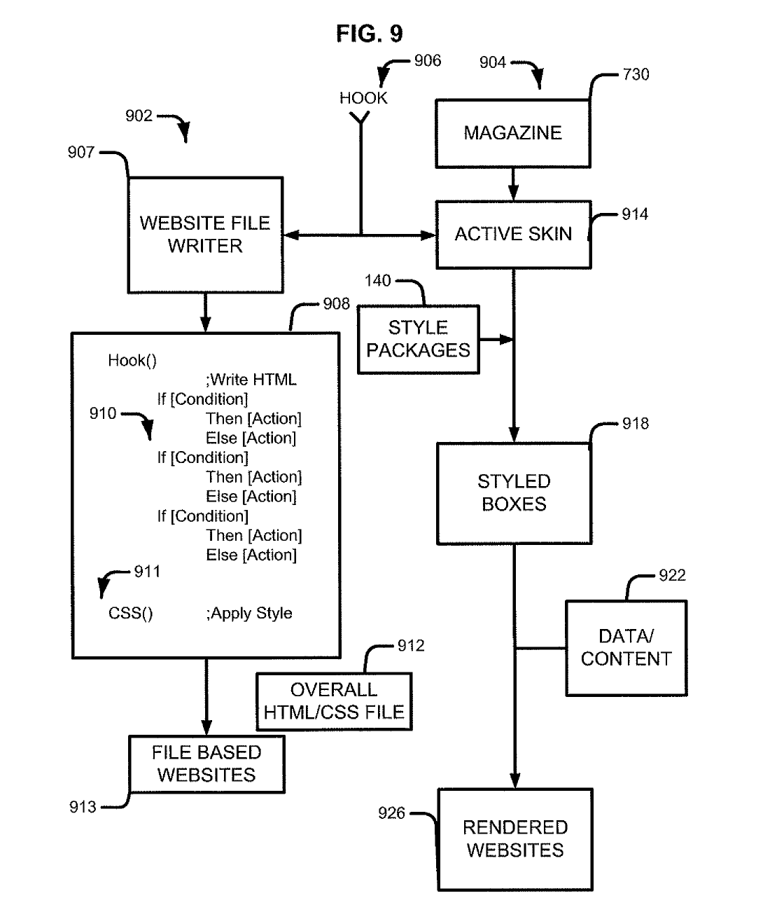

FIG. 9 illustrates two approaches for serving a website. In the first approach 902, when a user wishes to browse a conventional website created from HTML and CSS files, they cause a hook 906 to be issued to a conventional website building program (here, the website file writer 907). Once the file writer 907 receives the hook, it begins writing the HTML (and CSS) necessary to build the conventional website. The file writer 907 uses code 908 resembling that shown in FIG. 9 which includes a series of if-then-else statements 910 which (depending on the conditions present at the time of the call to the hook) write portions of HTML for the underlying HTML file 118 (see FIG. 1) for the website. The file writer 907 also writes the CSS code 911 into the overall file 912 (which contains both the HTML and CSS for the website) as illustrated by FIG. 9. The overall file 912 causes conventional web hosting servers to apply the targeted CSS code 911 to the structure and data/content identified by the rest of the overall file 912 (the HTML portion). As a result, the conventional website 913 can be served and is available for users to browse via conventional browsers.

However, the overall file 912 can be (or become) exposed to the public and potentially malicious (or at least negligent) actors. Moreover, because it is an executable file, these parties can hack it, thereby rendering the conventional website either partially or entirely inoperative. Additionally, such attacks can leave the conventional website 913 nominally functional while it performs malicious activities at the hacker's behest.

In contrast, the other approach illustrated by FIG. 9, functions differently in at least some aspects. Instead of creating the executable overall file 912, the approach 904 of the current embodiment renders websites 236 from the skins 141 (and/or the associated structural boxes 138, the style packages 140, and the references there between 230). More specifically, in the current approach 904, the web hosting server 226 accesses magazine 730 for a given website 236. It can then echo the structural boxes 138 of the active skin 700 with the referenced style packages 140 applied thereto. It can also populate the styled boxes 918 with the data/content 922 for the website 236 and render the website 926 for requesting browsers. In other words, instead of outputting a hackable (and corruptible) website file (the overall file 912), the current approach 904 outputs an echoed PHP file (including code for appropriate controls such as buttons, hyperlinks, etc.) which to a browsing user appears to be the website 236 and/or its overall file 912. A hacker attempting to access what they believe to be the executable and overall file 912 (the website code) will find, at best, the skin 700 or a list of structural boxes 138, their references 230 (perhaps), and little more. This meager information therefore renders the hacker impotent to edit, corrupt, the website 236 or its underlying structure, style, data, content, etc. Indeed unless the hacker can somehow access a corresponding account associated with the magazine manager 802 little exists that the hacker can do to the website 236.

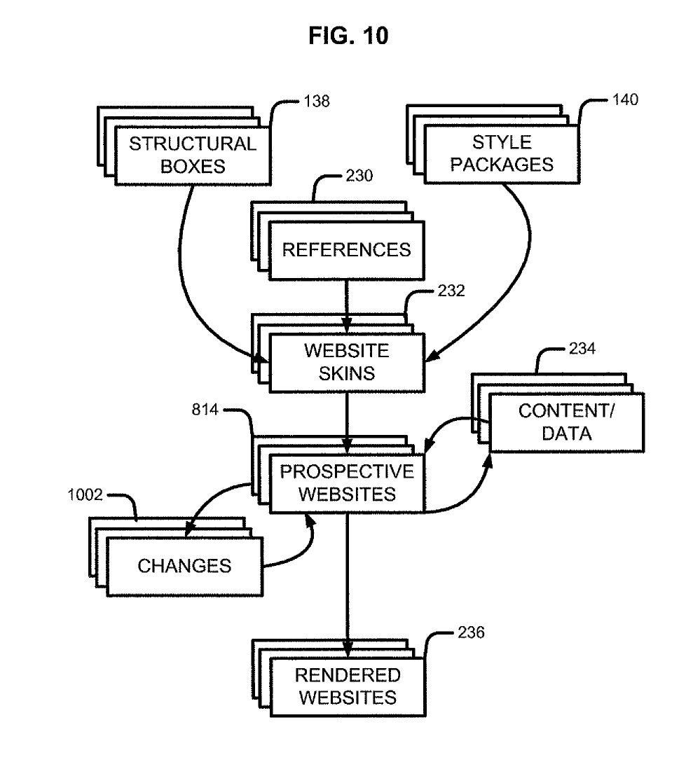

FIG. 10 illustrates a progression of a website over time. For a website 236 that has not yet been created, the website can begin as a user selects the various skins 141, structural boxes 138 and/or style packages 140 which they desire to use for the website 236. At some point the user can also add references 230 between the style packages 140 and the structural boxes 138 to indicate how the structural boxes 128 should be styled. The skin 232, in some instances, includes a list of structural boxes 138 to be styled in accordance with the style packages 140 as indicated by the references 230. These styled boxes then become populated with data/content 234 and become a prospective website 814 that can be changed by the user via the magazine manager 802 (see FIG. 8). If desired, the user can iterate the prospective website 814 while making prospective changes 1002 at their discretion and viewing the prospective results on the canvas 803. At some point, the user can decide to launch the prospective website 814 with some set of (otherwise) prospective changes 1002 (or none at all) incorporated therein. In such situations, the web hosting server 226 begins echoing the website 236 (while populating it with data/content) for requesting browsers as browsing requests for the website 236 are received and in accordance with the active skin.

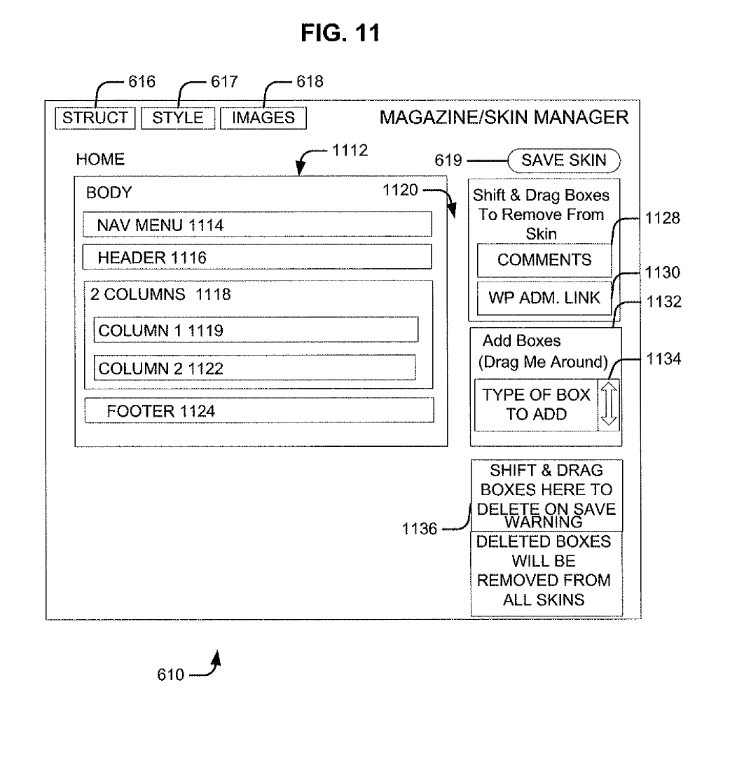

FIG. 11 illustrates a graphical user interface for managing a website skin. More specifically, FIG. 11 illustrates the GUI 610 including several controls 616-619 for managing the GUI 1100; a particular skin 1112 from a magazine; a series of structural boxes (or icons comprising the same) 1114, 1116, 1118, 1119, 1122, and 1124; and a structural box selection area 1120. The structural box selection area 1120 further illustrates icons representing some structural boxes 1128 and 1130 and controls 1132 and 1134 related to adding structural boxes to the selected skin 1112 illustrated by FIG. 11. FIG. 11 also illustrates a control 1136 for deleting/removing structural boxes from a skin if desired.

At one level, tab 616 allows a user to navigate to a portion of the GUI 610 which allows them to change structure related aspects of a selected skin 1112. Tab 617 allows a user to navigate to a portion of the GUI 1100 which allows them to change style related aspects of the selected skin 1112. Tab 618 allows a user to access and change images (and/or other audio, visual, and/or multi-media content associated with the skin) Another control 619 allows users to save the magazines 730 (and skins 1112 and their constituent components) when desired.

Furthermore, FIG. 11 illustrates that a user might have been making changes to the skin 1112. The GUI 610 therefore displays the series of structural boxes 1114, 1116, 1118, 1120, 1122, and 1124 included in that skin 1112. As is disclosed further herein, each of these structural boxes can be changed (or even edited if desired) via the GUI 610. More specifically, area 1120 allows a user to drag and drop structural boxes 1128 and 1130 from area 1126 to the skin 1112 to add boxes to the skin 1112. In doing so the user can drop a particular structural box 1128 or 1130 into a particular place in the order of the structural boxes in the skin 1112 and/or drag and drop the structural boxes 1114, 1116, 1118, 1120, 1122, and 1124 within the skin 1112 to change that order.

GUI 610 also includes control 1132 which allows a user to add structural boxes from an external library to the area 1120. The area 1120 allows them to be added to the skin 1112. To do so, a user can point and click on control 1134 which then provides a pop-up menu or other mechanism which allows the user to navigate to various libraries in which they can search for structural boxes. The GUI 610 also provides a control 1136 which allows users to delete structural boxes from the skin 1112 and/or the area 1120. In the current embodiment, deleting a structural box can be accomplished by clicking on it and dragging it to control 1136.

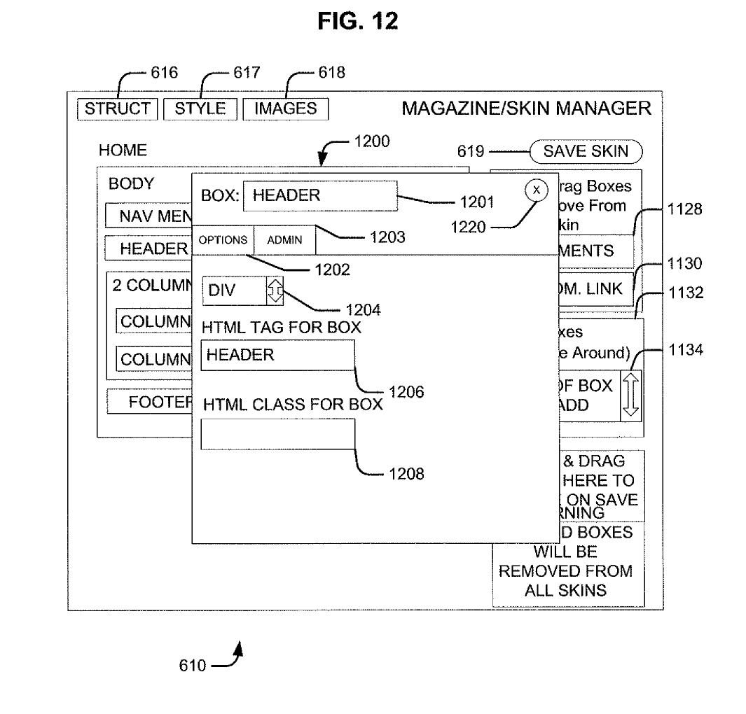

FIG. 12 illustrates a graphical user interface for managing structural boxes. More specifically, FIG. 12 illustrates a pop up menu 1200 which appears when a user selects one of the structural boxes 1114, 1116, 1118, 1120, 1122, and 1124 in the skin 1112 displayed by the GUI 610. The pop up window 1200 provides various controls 1201, 1202, 1203, 1204, 1206, and 1208 for creating, changing, managing, etc. the selected structural box. More specifically, these controls include field 1201 in which the name of the selected structural box appears. Tabs 1202 and 1203 respectively allow the user to select or set certain options with regard to the selected structural box and to perform certain administrative functions pertaining thereto.

For instance, the control 1204 allows a user to change the type of structure that the selected structural box represents. As those skilled in the art know, one common type of structure in an HTML document is a “div” section. Of course, other HTML-related structures can be selected via control 1204. Meanwhile, controls 1206 and 1208 allow users to define an identifier and a class, respectively, for the selected structural box. Of course, any of the controls associated with GUI 1100 can be programmed to provide English-level information or help to various users, and more specifically, non-developers. When finished changing a particular structural box, the user can close the pop-up window to save the changes via control 1220. The underlying system can then change the underlying code (or it can be programmed to do so as the changes are entered.)

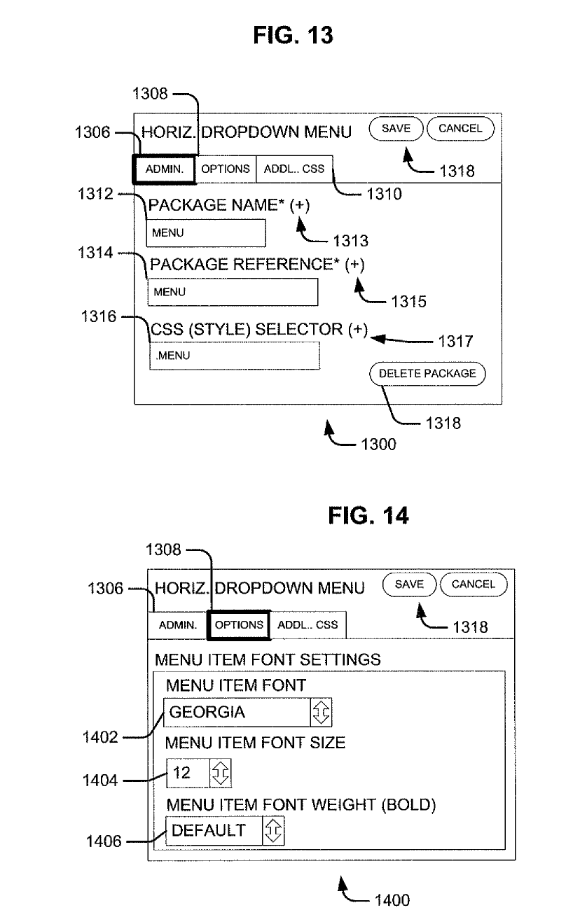

FIG. 13 illustrates a graphical user interface for managing style packages. When a user wants to change some stylistic aspect of a skin, the user can navigate to GUI 610 (see FIG. 11) and select the style-related control 1104. Doing so causes the style related pop up window 1300 to appear. Pop up window 1300 includes three tabs 1306, 1308, and 1310 allowing the user to access further controls for performing administrative tasks, changing various options, and entering additional CSS (or other style) code associated with particular style packages, respectively. More specifically, by selecting the administrative tab 1306, the user can cause the controls 1312-1318 to appear. Control 1312 provides a field wherein the user can select packages using the “+” button 1313 (which provides a list of style packages in the selected skin) as desired. The package reference control 1314 allows a user to select the various structural boxes to which they wish to apply the style defined by the selected style package. Again, the user can use a “+” button 1315 to access a list of structural boxes in the selected skin. In the alternative, or in addition, the user can use button 1317 to select a type of structure to which to apply the style defined by the selected style package via control 1316. For instance, the user could select that all structural boxes related to the .menu CSS selector be so styled. In these ways, and others depending on the embodiment, a user can graphically create references between structural boxes and style packages. Controls 1318 allow the user to cancel or accept the changes entered via pop up window 1300.

FIG. 14 illustrates another graphical user interface for managing style packages. In FIG. 14, the user has selected the options tab 1308. As a result, the pop up window 1400 has appeared and presents the user several additional controls. These controls relate to the selected style package and allow the user to graphically change various option associated therewith. For instance, control 1402 allows a user to click on a particular font and change the style of the selected style package accordingly. Control 1404 allows the user to graphically change the font size of a particular style defined by the selected style package instead of editing CSS code. In another instance, control 1406 allows the user to graphically change the font weight of the style to, for instance, change some text to bold text.

Of course, other features of GUI 610 allow users to navigate between magazines 730, skins 141, structural boxes 138, style packages 140 as desired. Thus, once a user has selected one of these objects, the user can then navigate to the more detailed portions of the GUI 610 dealing with specific skins 141, structural boxes 138, style packages 140, etc. Thus, FIGS. 6D, 6E, 8, and 11-14 illustrate some aspects of a graphical user interfaces of embodiments.

Embodiments provide systems, servers, and methods that will work with any kind of website to provide improved search engine performance, increased design flexibility, and improved loading times. The powerful and efficient PHP framework and easy to use point-and-click controls, of some embodiments, allows users to build, maintain, modify, change, fine-tune, etc. (without necessarily editing) their websites, the component pages, and other structures and styles thereof precisely and accurately. Features provided by various embodiments therefore free the user from tedious, error-prone, and/or code-intensive editing allowing them to concentrate on developing content for their websites or otherwise improving it. Moreover, embodiments allow users to evaluate prospective changes to their websites without actually launching the changed website and to do so on one display screen. Furthermore, embodiments enable users to improve their website readability and/or performance by improving their typography and visual clarity through, in part, leveraging tools provided by various embodiments.

### CONCLUSION

Although the subject matter has been disclosed in language specific to structural features and/or logical acts, it is to be understood that the subject matter defined in the appended claims is not necessarily limited to the specific features or acts disclosed above. Rather, the specific features and acts described herein are disclosed as illustrative implementations of the claims.

1. A method comprising:
in accordance with a first user selection of a skin associated with at least a portion of a website and using a processor, activating the selected skin wherein the selected skin comprises at least one structural box comprising structure related code defining structure for the portion of the website;
receiving a request from a requestor to serve the portion of the website over a network; and
responsive to the request and using the processor, outputting the structure related code and style related code applied thereto in accordance with at least one reference between the at least one structural box and at least on style package comprising the style related code, the style related code defining a style.

2. The method of claim 1 wherein the outputting occurs in an order associated with the at least one structural box.

3. The method of claim 1 wherein the receiving a request further comprises receiving a call to a hook associated with the website.

4. The method of claim 1 further comprising accepting a second user selection of another skin associated with the portion of the website and activating the other skin.

5. The method of claim 1 further comprising accepting a change to another skin associated with the portion of the website and displaying an effect of the change leaving the portion of the website unaffected by the change.

6. The method of claim 1 further comprising accepting an edit to the selected skin.

7. The method of claim 1 further comprising accepting a second user selection of another skin and associating it with the portion of the website.

8. The method of claim 1 further comprising accepting a change to the selected skin within the context of a browser.

9. The method of claim 1 wherein the outputting further comprises echoing PHP code.

10. A machine readable medium storing machine readable instructions thereon which when executed by a machine cause the machine to perform a method comprising:
in accordance with a first user selection of a skin associated with at least a portion of a website, activating the selected skin wherein the selected skin comprises at least one structural box comprising structure related code defining structure for the portion of the website;
receiving a request from a requestor to serve the portion of the website; and
responsive to the request, outputting the structure related code and style related code applied thereto in accordance with at least one reference between the at least one structural box and at least on style package comprising the style related code, the style related code defining a style.

11. The machine readable medium of claim 10 wherein the outputting occurs in an order associated with the at least one structural boxes.

12. The machine readable medium of claim 10 wherein the receiving a request further comprises receiving a call to a hook associated with the portion of the website.

13. The machine readable medium of claim 10 wherein the method further comprises accepting a second user selection of another skin associated with the portion of the website and activating the other skin.

14. The machine readable medium of claim 10 wherein the method further comprises accepting a change to another skin associated with the portion of the website and displaying an effect of the change while leaving the portion of the website unaffected by the change.

15. The machine readable medium of claim 10 wherein the method further comprises accepting a second user selection of another skin and associating it with the portion of the website.

16. A webhosting server comprising:
a network interface;
a memory; and
a processor in communication with the network interface and the memory, the memory storing processor readable instructions which when executed by the processor cause the processor to execute a method further comprising,
accepting a first user selection of at least one website skin for inclusion in a magazine, the website skins each having at least one structural box encapsulating HTML code defining structure for the website, at least one style package encapsulating CSS code defining style, and a reference between the structural box and the style package,
associating the website skins with a website in the magazine,
in accordance with a second user selection of one of the skins associated with the website in the magazine, activating the selected skin in accordance with the second user selection,
receiving a request from a requesting browser to serve the website over a network in communication with the interface; and
responsive to the request, echoing the structure related code and style related code applied thereto in accordance with at least the reference between the at least one structural box and the at least on style package of the selected skin in the magazine whereby the webhosting server serves echoed PHP code reflecting the HTML code and the applied CSS code.

17. The webhosting server of claim 16 wherein the receiving a request further comprises receiving a call to a hook associated with the website.

18. The webhosting server of claim 16 wherein the method further comprises accepting a third user selection of another skin associated with the portion of the website and activating the other skin.

19. The webhosting server of claim 16 wherein the method further comprises accepting a change to another skin associated with the website and displaying an effect of the change while leaving the portion of the website unaffected by the change.

20. The webhosting server of claim 16 wherein the method further comprises accepting an edit to the selected skin.
